(19) United States
(12) Patent Application Publication
(10) Pub. No.: US 2014/0189155 A1
(43) Pub. Date: Jul. 3, 2014

(54) Methods, Systems, and Computer Program Products for Determining a Protocol Address For a Node

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/727,657

(22) Filed: Dec. 27, 2012

(51) Int. Cl. H04L 29/12

(52) U.S. Cl. 709/238

(57) ABSTRACT

Methods and systems are described for determining a protocol address for a node. In an aspect, hop identifier is identified, which for a first node in a network identifies a hop that includes a pair of consecutive nodes in a network path in the network. A first protocol address is received that for a network protocol at least one of identifies the first node to a second node in the network and identifies the second node to the first node, wherein the second node is not in the hop. Based on the first protocol address and the hop identifier, a second protocol address is determined that for the network protocol at least one of identifies a node in the hop that is not the first node to the second node and identifies the second node to a node in the hop that is not the first node.

### RELATED APPLICATIONS

This application is related to the following commonly owned, pending U.S. patent applications, by the present inventor, the entire disclosures being incorporated by reference herein:
application Ser. No. 13/727,647 (Docket No DRV0025) filed on 2012 Dec. 27, entitled “Methods, Systems, and Computer Program Products for Identifying a Protocol Address Based on Path Information”;
application Ser. No. 13/727,649 (Docket No DRV0026) filed on 2012 Dec. 27, entitled “Methods, Systems, and Computer Program Products for Assigning an Interface Identifier to a Network Interface”;
application Ser. No. 13/727,651 (Docket No DRV0027) filed on 2012 Dec. 27, entitled “Methods, Systems, and Computer Program Products for Routing Based on a Nested Protocol Address”;
application Ser. No. 13/727,652 (Docket No DRV0028) filed on 2012 Dec. 27, entitled “Methods, Systems, and Computer Program Products for Routing Based on a Scope-specific Address Space”;
application Ser. No. 13/727,653 (Docket No DRV0029) filed on 2012 Dec. 27, entitled “Methods, Systems, and Computer Program Products for Identifying a Protocol address in a Scope-specific Address Space”;
application Ser. No. 13/727,655 (Docket No DRV0030) filed on 2012 Dec. 27, entitled “Methods, Systems, and Computer Program Products for Determining a Shared identifier for a Hop in a Network”; and
application Ser. No. 13/727,662 (Docket No DRV0032) filed on 2012 Dec. 27, entitled “Methods, Systems, and Computer Program Products for Routing Based on a Path-Based Protocol Address”.

### BACKGROUND

It is unlikely that the designers of the early network, which is referred to as the “Internet” expected it to become as large as it has become. The fact that the global Internet Protocol (IP) address space, for 32-bit addresses, has been fully allocated is evidence of this. As the Internet grows, new problems will arise and some current problems are getting worse. For example, while network speeds and bandwidth are increasing, so are causes of network latency.

The Internet Engineering Task Force (IETF) has taken steps at various times in the past and are presently taking steps to address a number of problems resulting from the Internet's growth. Problems addressed by the IETF are described in a number of “Request for Comments” (RFC) documents published by the IETF. Documents referenced herein and included by reference include: “Request for Comments” (RFC) document RFC 791 edited by J. Postel, titled ““Internet Protocol, DARPA Internet Protocol Specification”, published by the IETF in September, 1981;

“Request for Comments” (RFC) document RFC 1519 by V. Fuller, et al, titled “Classless Inter-Domain Routing (CIDR): An Address Assignment and Aggregation Strategy”, published by the Internet Engineering Task Force (IEFT), in June, 1999;

“Request for Comments” (RFC) document RFC 2460 by S. Deering, et al, titled “Internet Protocol, Version 6, (IPv6) Specification”, published by the IETF in December, 1998;

“Request for Comments” (RFC) document RFC 3513 by R. Hinden, et al, titled ““Internet Protocol Version 6 (IPv6) Addressing Architecture”, published by the IETF in April, 2003; and

“Request for Comments” (RFC) document RFC 2374 by R. Hinden, et al, titled ““Aggregatable Global Unicast Address Format”, published by the IETF in July, 1998.

RFC 791 states, “The internet protocol implements two basic functions: addressing and fragmentation”. RFC 791 goes on to state, “A distinction is made between names, addresses, and routes. A name indicates what we seek. An address indicates where it is. A route indicates how to get there. The internet protocol deals primarily with addresses. It is the task of higher level (i.e., host-to-host or application) protocols to make the mapping from names to addresses. The internet module maps internet addresses to local net addresses. It is the task of lower level (i.e., local net or gateways) procedures to make the mapping from local net addresses to routes”.

As demonstrated by the RFCs listed above addressing has been a source of a number of problems. In order to address a number of current and future problems facing the Internet, the subject matter described herein challenges the distinctions asserted in RFC 791 and establishes new relationships between and among names, addresses, and routes. The description herein further demonstrates that current internet addresses do not indicate where a node or network interface component (N I C) of a node is. They provide another global identifier space for identifying nodes and their network interfaces. This global identifier space, to some extent, is duplicative of the domain name space that is also a global identifier space for identifying nodes and network interfaces. This duplication of roles is unnecessary as described below.

Accordingly, there exists a need for methods, systems, and computer program products for determining a protocol address for a node.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for determining a protocol address for a node. In one aspect, the method includes identifying a first hop identifier that is, for a first node in a network, an identifier of a first hop that includes a pair of consecutive nodes in a network path in the network. The method further includes receiving a first protocol address that for a network protocol at least one of identifies the first node to a second node in the network and identifies the second node to the first node, wherein the second node is not in the first hop. The method still further includes determining, based on the first protocol address and the first hop identifier, a second protocol address that for the network protocol at least one of identifies, to the second node, a node in the first hop that is not the first node and identifies the second node, to a node in the first hop, that is not the first node. Performing at least one of the above elements in the method includes execution of an instruction by a processor.

Further, a system for determining a protocol address for a node is described. The system includes a hop manager component that is operable for and/or otherwise included in identifying a first hop identifier that is, for a first node in a network, an identifier of a first hop that includes a pair of consecutive nodes in a network path in the network. The system further includes an address space director component operable for and/or otherwise included in receiving a first protocol address that for a network protocol at least one of identifies the first node to a second node in the network and identifies the second node to the first node, wherein the second node is not in the first hop. The system still further includes an topology component operable for and/or otherwise included in determining, based on the first protocol address and the first hop identifier, a second protocol address that for the network protocol at least one of identifies, to the second node, a node in the first hop that is not the first node and identifies the second node, to a node in the first hop, that is not the first node. The system also includes a processor, wherein at least one of the hop manager component, the address space director component, and the topology component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for determining a protocol address for a node according to an aspect of the subject matter described herein;

FIG. 3 is a block diagram illustrating an arrangement of components for determining a protocol address for a node according to another aspect of the subject matter described herein;

FIG. 4A is a block diagram illustrating an arrangement of components for determining a protocol address for a node according to another aspect of the subject matter described herein;

FIG. 4B is a block diagram illustrating an arrangement of components for determining a protocol address for a node according to another aspect of the subject matter described herein;

FIG. 5A is a network diagram illustrating an exemplary system for determining a protocol address for a node according to another aspect of the subject matter described herein;

FIG. 5B is a network diagram illustrating an exemplary system for determining a protocol address for a node according to another aspect of the subject matter described herein;

FIG. 5C is a network diagram illustrating an exemplary system for determining a protocol address for a node according to another aspect of the subject matter described herein;

FIG. 6A is a diagram illustrating an exemplary representation of a protocol address according to another aspect of the subject matter described herein;

FIG. 6B is a diagram illustrating an exemplary representation of a protocol address according to another aspect of the subject matter described herein;

FIG. 6C is a diagram illustrating an exemplary representation of a protocol address according to another aspect of the subject matter described herein; and

FIG. 6D is a diagram illustrating an exemplary representation of a protocol address according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments and/or aspects may be utilized and structural and functional modifications may be made without departing from the scope of the subject matter disclosed herein.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided to”, “received from”, “identified to”, “interoperated” and similar terms and their variants.

As used herein, any reference to an entity “in” an association is equivalent to describing the entity as “included in and/or identified by” the association, unless explicitly indicated otherwise.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

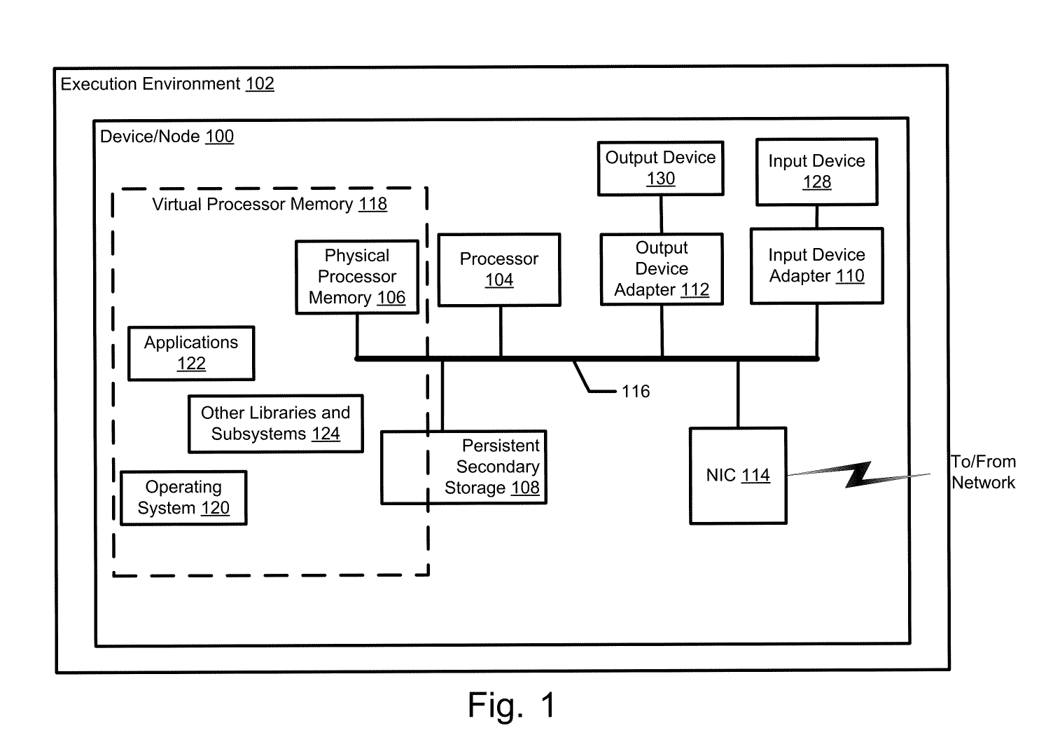

An exemplary device included in an execution environment that may be programmed, adapted, modified, and/or otherwise configured according to the subject matter is illustrated in FIG. 1. An “execution environment”, as used herein, is an arrangement of hardware and, in some aspects, software that may be further modified, transformed, and/or otherwise configured to include and/or otherwise host an arrangement of components to perform a method of the subject matter described herein. An execution environment includes and/or is otherwise provided by one or more devices. The execution environment is said to be the execution environment “of” the device and/or devices. An execution environment may be and/or may include a virtual execution environment including software components operating in a host execution environment. Exemplary devices included in and/or otherwise providing suitable execution environments that may be adapted, programmed, and/or otherwise modified according to the subject matter include a workstation, a desktop computer, a laptop or notebook computer, a server, a handheld computer, a mobile telephone or other portable telecommunication device, a media playing device, a gaming system, a tablet computer, a portable electronic device, a handheld electronic device, a multiprocessor device, a distributed system, a consumer electronic device, a router, a network server, or any other type and/or form of computing, telecommunications, network, and/or media device that is suitable to perform the subject matter described herein. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for computer-executable instructions, data structures, program components, and other data.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 may receive input and provide a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component. Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., AMPS, TDMA, CDMA, GSM, GPRS UMTS, and/or PCS network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A “user interface (UI) element handler” component, as the term is used herein, refers to a component that operates to send information representing a program entity to present a user-detectable representation of the program entity by an output device, such as a display. A “program entity” is an object, such as a variable or file, included in and/or otherwise processed by an application or executable. The user-detectable representation is presented based on the sent information. Information that represents a program entity to present a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send information representing one or more program entities to present particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

An “interaction”, as the term is used herein, refers to any activity including a user and an object where the object is a source of sensory data detected by the user and/or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is receiving sensory information from the portable electronic. An interaction may include an input from the user that is detected and/or otherwise sensed by the device. An interaction may include sensory information that is received by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect a user's head turn in the direction of a display of a portable electronic device. Interaction information indicating that the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus, the interaction information may serve as interaction information for one or more different objects.

As used herein, the terms “program” and “executable” refer to any data representation that may be and/or may be translated into a set of machine code instructions and may optionally include associated program data. The terms are used interchangeably herein. Program representations other than machine code include object code, byte code, and source code. Object code includes a set of instructions and/or data elements that either are prepared to link prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. A program and/or executable may include one or more components, referred to herein as a “program component”, a “software component”, and/or an “executable component”. As used herein, the terms “application”, and “service” may be realized in one or more program components and/or in one or more hardware components.

As used herein, the term “network protocol” refers to a set of rules, conventions, and/or schemas that govern how nodes exchange information over a network. The set may define, for example, a convention and/or a data structure. The term “network path” as used herein refers to a sequence of nodes in a network that are communicatively coupled to transmit data in one or more data units of a network protocol between a pair of nodes in the network.

A “data unit”, as the term is used herein, is an entity specified according to a network protocol to transmit data between a pair of nodes in a network path to send the data from a source node to a destination node that includes an identified protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting an IP packet that defines a header to identify a destination address that identifies a destination node and a payload portion to include a representation of data to be delivered to the identified destination node. Various address types are specified defining a vocabulary for one or more address portions of an IP data unit. The terms “data unit”, “frame”, “data packet”, and “packet” are used interchangeably herein. One or more data units of a first network protocol may transmit a “message” of a second network protocol. For example, one or more data units of the IP protocol may include a TCP message. In another example, one or more TCP data units may transmit an HTTP message. A message may be empty.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units to transmit to a next node in the network path. Portions of data received in several data units may be combined into a single data unit to transmit by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the network protocol. For example, 192.168.1.1 is an IP protocol address represented in a human readable format that may be represented in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

A node in a pair of nodes in a network path at one end of the sequence of nodes in the network path and/or the other end is referred to herein as a “path end node”. Note that a node may have two NICs with one NIC at each end of a network path. A network path may be included as a portion of another network path that communicatively couples a same pair of nodes. Data may be transmitted via the sequence of nodes in a network path between path end nodes communicatively coupled via the network path. Data may be transmitted in one or both directions depending on an ordering of the nodes in the sequence.

The term “hop” as used herein refers to a pair of consecutive nodes in a network path to transmit, via a network protocol, data sent from a source node to a destination node. A “hop path” is thus a sequence of hops in a network that respectively include a sequence of pairs of consecutive nodes included in transmitting data from a first path end node of the network path to a second path end node of the network path.

The term “path-based protocol address” as used herein refers to a protocol address for a network protocol that includes one or more path segment identifiers that identify one or more respective portions of a network path identified by the path-based protocol address. A “node-based protocol address” is a path-based protocol address that includes a plurality of node identifiers that identify a sequence of nodes in a network path. A “network-interface-based protocol address” is a path-based protocol address that includes a plurality of interface identifiers that identify a sequence of network interfaces in a network path. A “NIC-based protocol address” is a type of network-interface-based protocol address that includes a plurality of identifiers that identify a sequence of network interface components. A “hop-based protocol address” is a type path-based protocol address since a hop is a type of network path.

Given the above definitions, note that the terms “network path” and “hop” may be defined in terms of network interfaces. A “network path” and a “hop path” include a sequence of network interfaces in a network that are included in transmitting data between a pair of path end nodes in the network. A “hop” refers to at least part of a network path that includes a pair of consecutive network interfaces in a sequence of network interfaces in a network path. A “network path” is thus a sequence of hops in a network that respectively includes a sequence of pairs of consecutive network interfaces included in transmitting data from a first path end node of the network path to a second path end node of the network path.

The term “network topology” or “topology”, for short, as used herein refers to a representation of protocol endpoints and/or nodes in a network, and representations of hops representing communicative couplings between and/or among the protocol endpoints and/or nodes in the network. A network may have different network topologies with respect to different network protocols. A network topology may represent physical communicative couplings between nodes in the network. A network topology may represent logical couplings between protocol endpoints and/or nodes of a particular network protocol or a particular type of network protocol.

The domain name system (DNS) of the Internet operates based on an application layer protocol defined by the DNS. The nodes in the DNS are communicatively coupled via the DNS protocol and may be represented by a logical network topology. A DNS system includes nodes connected via the DNS protocol. The DNS system has a network topology defined by nodes that include protocol endpoints of the DNS protocol. In still another example, a token-ring network has a circular topology at the link layer, but may have a star topology at the physical layer.

As used herein, an “entity-specific address space” refers to an address space defined for a specific entity where the addresses in the address space operate as identifiers in the context of the entity. An address from an entity-specific address space is referred to herein as an “entity-specific address”. An address is “entity-specific” in that what it identifies is based on the entity to which it is specific. Another address having the same form and content may identify a different entity when in an address space specific to another entity. Addresses in an entity-specific address space operate as identifiers in the context of an entity to which they are “specific” as defined by the specific association of the address space and the entity. Without knowledge of the entity to which an entity-specific address space is specific, what an address in the entity-specific address space identifies is indeterminate. The terms “entity-specific address” and “entity-specific identifier” are used interchangeably herein. An entity-specific address may identify an entity included in the entity to which the address is specific or may identify an entity external to the entity to which the address is specific. The fact that an address is entity-specific does not define a scope for the address.

A portion of a network is a type of entity. A type of entity-specific address space described herein is a scope-specific address space. As used herein, a “scope-specific address space”, specific to a particular region of a network, is an address space defined for the particular network region, where an address in the scope-specific protocol address operates as identifier, according to a network protocol, of a protocol endpoint in a node outside of the particular region when processed in the context of a node in the particular region. The region is indicated by the span of an indicated scope. The terms “region” and “zone” are used interchangeably herein. An address from a scope-specific address space is referred to herein as a “scope-specific protocol address”. An address is “scope-specific” in that what protocol endpoint it identifies depends on the region to which it is specific. Another address having the exact same form and content may identify a different protocol endpoint when in an address space that is specific to another region. A protocol address in a scope-specific address space serves as an identifier in the context of a node in a region to which the scope-specific address space is “specific” as defined by an association of the address space and the region indicated by the scope. Without knowledge of the particular region to which a scope-specific address space is specific, what a scope-specific protocol address in the scope-specific address space identifies is indeterminate. The terms “scope-specific protocol address” and “scope-specific protocol identifier” are used interchangeably herein. Types of scope-specific address spaces indicating exemplary spans include site-specific, LAN-specific, subnet-specific, city-specific, business-specific, and node-specific.

For a network protocol, an address in a scope-specific address space serves as an identifier of a protocol endpoint in a node. Data may be received via the protocol endpoint from a network via one or more network interfaces that operatively couple the node to the network. Data may be sent via the protocol endpoint to transmit over the network via the one or more network interfaces in the node. Since a protocol endpoint of a network protocol is included in a node and is accessible via a network via a network interface, a protocol address identifying the protocol endpoint also identifies the node and identifies a network interface of the node.

As used herein, a “node-specific address space” is a scope-specific address space defined for a specific node in a network, where the addresses in the node-specific address space operate as identifiers of nodes and/or network interfaces in the network when processed in the context of the specific node. An address from a node-specific address space is referred to herein as a “node-specific address”. An address is “node-specific” in that what it identifies depends on the node to which is defined as specific. Another address having the exact same form and content may identify a different node when in an address space specific to another node. Addresses in a node-specific address space operate as identifiers in the context of a node to which they are “specific” as defined by the specific association of the address space and the node. Without knowledge of the node to which a node-specific address space is specific, addresses in the node-specific address space are indeterminate. The terms “node-specific address” and “node-specific identifier” are used interchangeably herein. A node-specific address space is a type of scope-specific address space.

The term “node” is defined above. Note that an identifier of a network interface in a network also identifies a node that includes the network interface. Thus, a network interface-specific address is also a node-specific address. Network interfaces in a node may have their own respective network interface-specific address spaces that are also node-specific. The network interface-specific address spaces may be combined to form a node-specific address space and/or may be managed as separate address spaces. The adjectives “node-specific” and “network interface-specific” may be used interchangeably.

A scope-specific identifier differs from a scoped address as described in “Request for Comments” (RFC) document RFC 4007 by S. Deering, et al, titled “IPv6 Scoped Address Architecture”, published by the IETF in December, 2006 and further described in application Ser. No. 11/962,285, by the present inventor, filed on 2007 Dec. 21, entitled “Methods and Systems for Sending Information to a zone Included in an Internet Network”. A scoped address space is shared by nodes in a given scope. While a link-local scoped address is specific to a particular node, a link-local scoped address simply identifies a network interface component local to the particular node. A loop-back internet address is specific to a node as well. Neither link-local scoped addresses nor loop-back addresses identify one node to another. As such, neither serves as a node-specific identifier as defined above.

A “scoped address” is described by RFC 3513 and RFC 4007 as an identifier that, in a particular region of a network, serves as a protocol address of a network interface and/or a node in the particular region. The extent of the particular region is referred to as the scope of the region and thus the scope within which the identifier serves as a protocol address. A particular region included within a scope is indicated by its span. A scoped address is a valid protocol address only within a particular region as indicated by the address's indicated scope. Examples of scope indicators include node-scope where identifiers are valid only to a single node in the indicated span, LAN-scope where identifiers are valid for nodes in the span of a particular LAN, and subnet-scope where identifiers are valid only for nodes in a particular subnet. RFC 3513 currently defines support for link-local scope, site-local scope, and global scope. A data unit transmitted with a scoped address should not be delivered to node that does not have a network interface in the span indicated by the scope.

“Path information” is any information that identifies a network path and/or a hop path for data transmitted via one a specified network protocols. Path information may be identified by identifying network interfaces, NICs, nodes, and/or hops included in a network path. “Address information” is any information that identifies a protocol address that, for a network protocol, identifies a protocol endpoint. Address information may identify a unicast protocol address for a network protocol. In identifying a protocol endpoint, a protocol address identifies a node and a network interface.

Those skilled in the art will understand upon reading the descriptions herein that the subject matter disclosed herein is not restricted to the network protocols described and/or their corresponding OSI layers. For ease of illustration, the subject matter is described in terms of protocols that correspond to OSI layer three, also referred to as network layer protocols, in general. Particular descriptions are based on versions of the Internet Protocol (IP). Address information may identify one or more protocol addresses. Exemplary protocol addresses include IP addresses, IPX addresses, DECNet addresses, VINES Internet Protocol addresses, and Datagram Delivery Protocol (DDP) addresses, HTTP URLS, TCP port and IP address pairs, and the like.

The term “path-based address” is defined above. A “node-based address” is a path-based address where some or all of the address includes node identifiers that identify a sequence of nodes in a network path. A “network-interface-based address” is a path-based address where some or all of the address includes identifiers of network interfaces in a sequence in a network path. A “NIC-based address” is a type of network-interface-based address that identifies a sequence of network interface components. A “hop-based address” is a path-based address where some or all of the address identifies one or more hops in a network path. The protocol address types defined are not mutually exclusive.

The term “metric space”, as used herein, refers to a set, as defined in mathematics, where a distance between elements of the set is defined according to a metric. Metric spaces defined in Euclidean geometry are well-known examples. Those skilled in the art of metric spaces, such as Euclidian spaces, will appreciate that a one-to-one mapping may be determined and/or otherwise identified for mapping addresses from a first coordinate space having a first origin for a metric space to addresses from a second coordinate space having a second origin in the metric space. Given a mapping rule between a first scope-specific address space and a second scope-specific address space and a mapping between the second scope-specific address space and a third scope-specific address space based on a third coordinate space identifying a third origin in the metric space, a mapping from the first coordinate space to the third coordinate space may be determined. A mapping between coordinate spaces for a metric space may be included a coordinate shift and/or a rotation, for example. The mapping may be pre-specified and accessible to the nodes in one or both address spaces. Mapping between locations in a number of different metric spaces is well known in mathematics. For example, a top half of the surface of sphere may be mapped to a plane. Some will further appreciate that some metric spaces may be mapped to other metric spaces. Some of these mappings are one-to-one and/or onto.

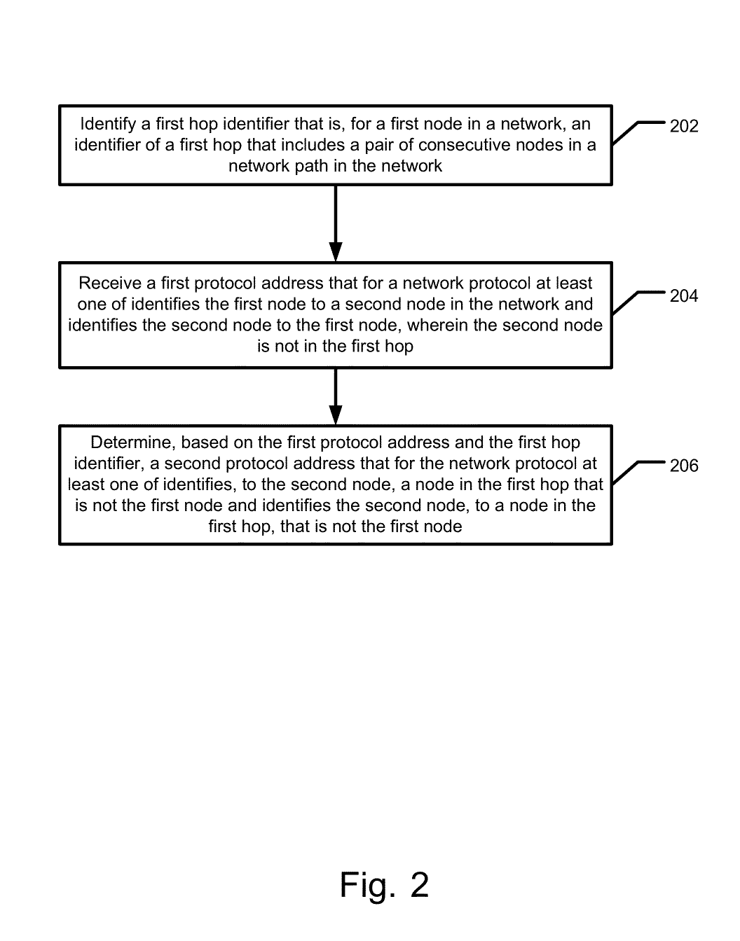

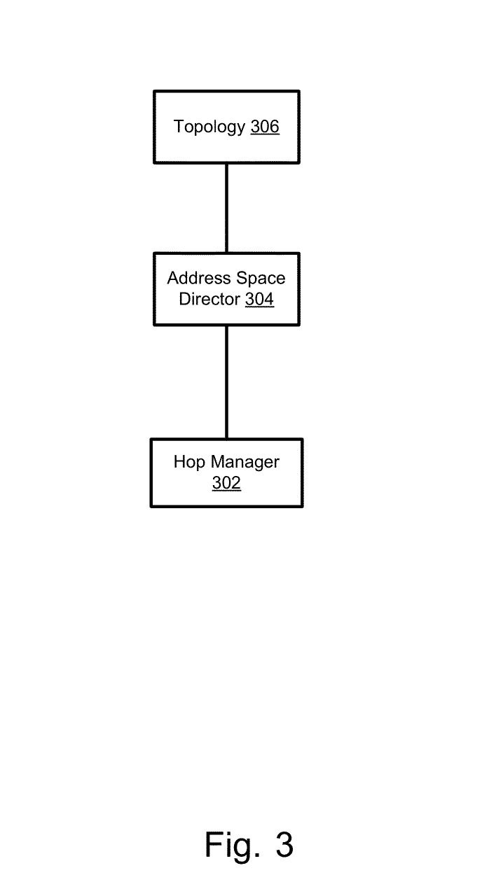

FIG. 3 illustrates an arrangement of components in a system that operates in an execution environment, such as execution environment 102 in FIG. 1. The arrangement of components in the system operates to perform the method illustrated in FIG. 2. The system illustrated includes a hop manager component 302, an address space director component 304, and a topology component 306. The execution environment includes a processor, such as the processor 104, to process an instruction in at least one of the hop manager component 302, the address space director component 304, and the topology component 306.

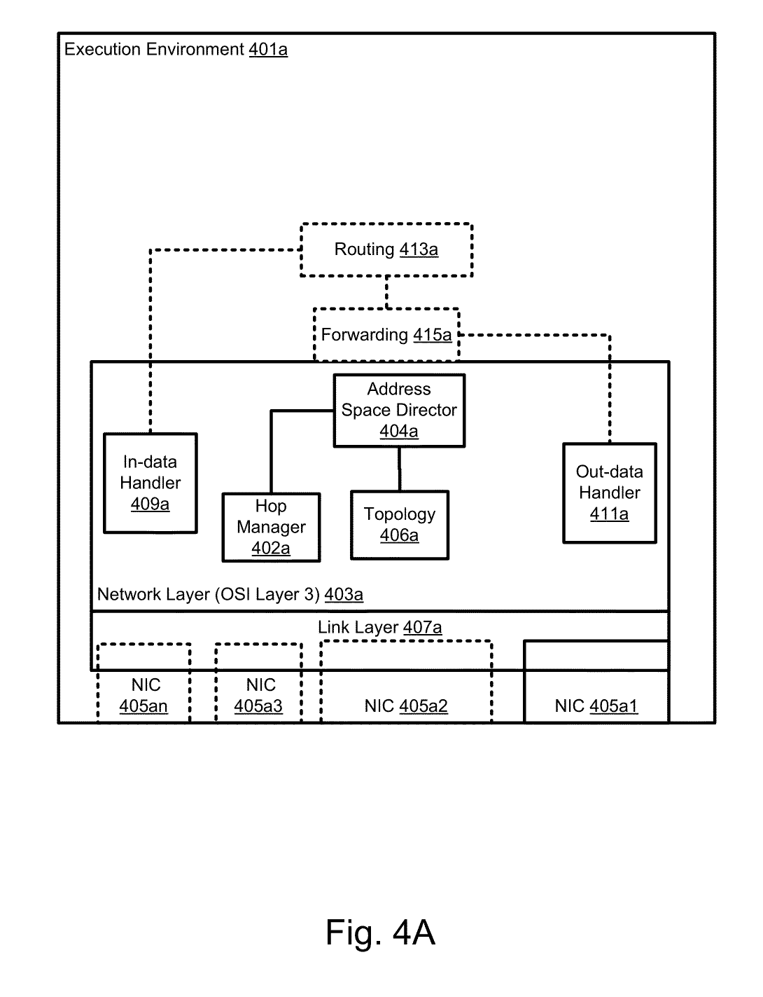

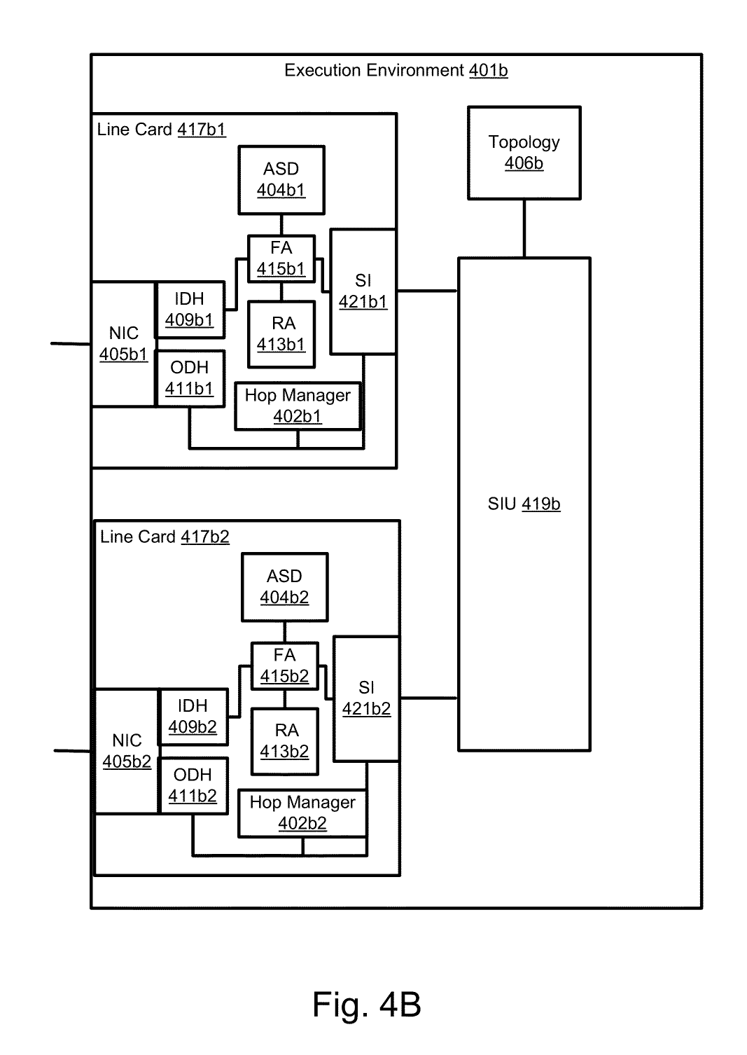

Some or all of the exemplary components illustrated in FIG. 3 may perform the method illustrated in FIG. 2 in a number of execution environments. FIGS. 4A-B are each block diagrams illustrating the components of FIG. 3 and/or analogs of the components of FIG. 3 respectively adapted for operation in execution environment 401a and execution environment 401b that each include and/or otherwise are provided by one or more nodes. Components, illustrated in FIG. 4A and FIG. 4B, are identified by numbers with an alphanumeric suffix. A component may be referred to generically in the singular or the plural by dropping a suffix of a portion thereof of the component's identifier. Execution environments; such as execution environment 401a and execution environment 401b, and their adaptations and analogs; are referred to herein generically as execution environment 401 or execution environments 401 when describing more than one. Other components identified with an alphanumeric suffix may be referred to generically or as a group in a similar manner.

FIG. 1 illustrates key components of an exemplary device that may at least partially provide and/or otherwise be included in an execution environment. Some or all of the components illustrated in FIG. 4A and FIG. 4B may be included in or otherwise may be combined with the components of FIG. 1 to create a variety of arrangements of components according to the subject matter described herein. Those skilled in the art will understand that various adaptations of the arrangement in FIG. 3 illustrated and described herein, as well as the herein illustrated and described execution environments suitable to host an adaptation of the arrangement in FIG. 3, are not exhaustive.

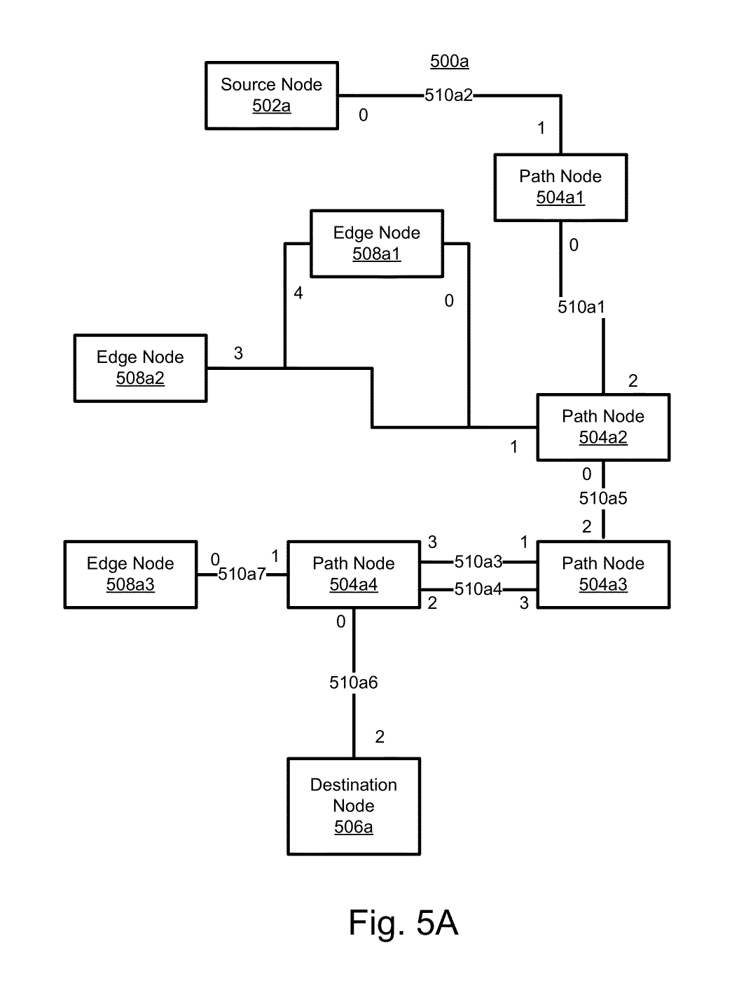

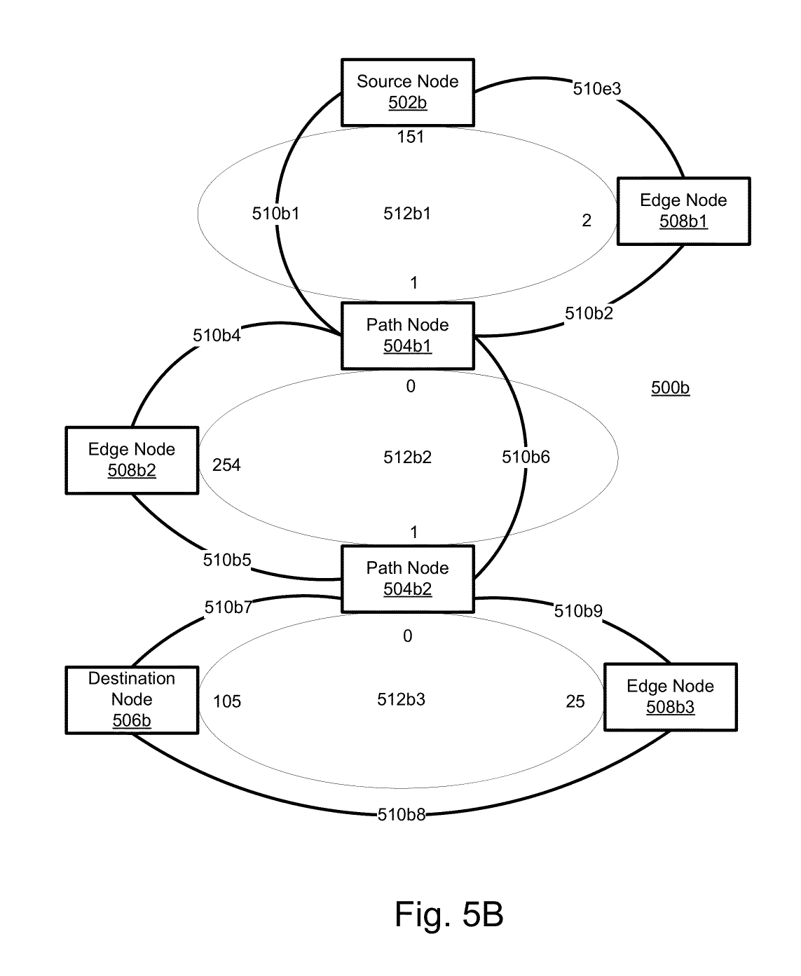

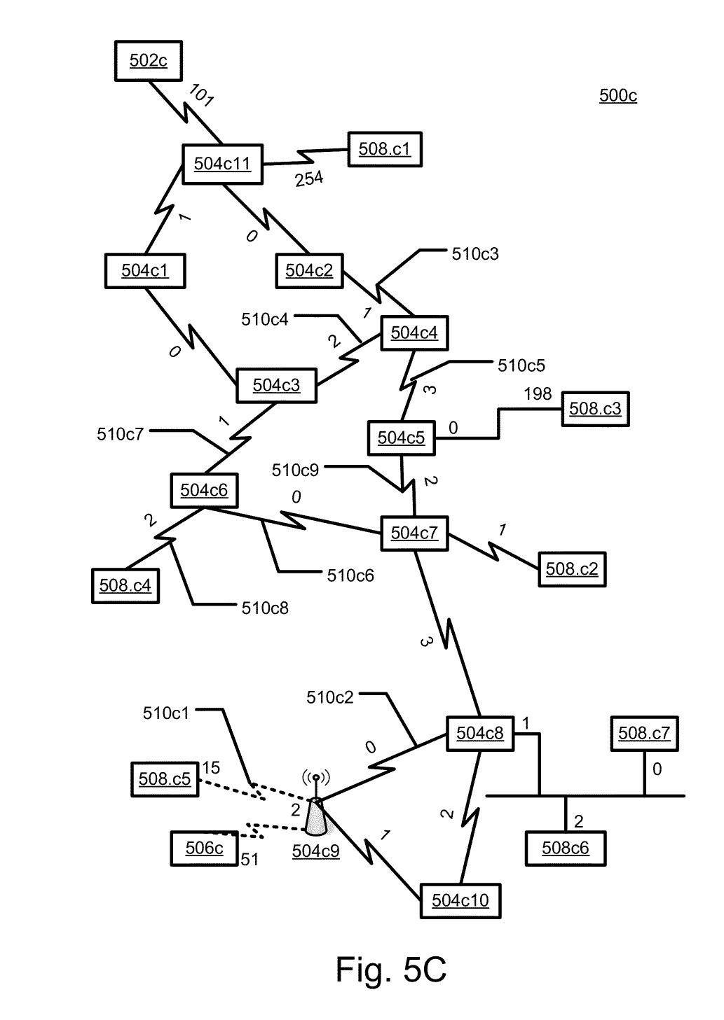

FIGS. 5A-C respectively illustrate networks 500 including nodes that in various aspects may include adaptations, analogs, and/or instances of any of the execution environments 401, illustrated in FIG. 4A and FIG. 4B. The various illustrated nodes are operatively coupled or may be operatively coupled via network interface components to the respective networks 500 in FIGS. 5A-C. For ease of illustration and description, each of FIGS. 5A-C includes nodes identified by a role played in sending data from one node to another. FIGS. 5A-C illustrate source nodes 502 that may initiate a transmission of data to respective recipients, path nodes 504 that may relay the data transmitted by respective source nodes 502, and destination nodes 506 including protocol endpoints identifying respective recipients of the data sent by the source nodes 502. In some of FIGS. 5A-C, one or more edge nodes 508 are illustrated for describing adaptations of the arrangement in FIG. 3 performing various aspects of the method illustrated in FIG. 2 operating in the role of a destination node and/or in the role of a source node.

FIG. 5B, illustrates a network path communicatively coupling the source node 502b and a second edge node 508b2 in the network 500b that includes a sequence of nodes including of the source node 502b, a first path node 504b1, and the second edge node 508b2. In FIG. 5C, a first network path communicatively coupling a fifth edge node 508c5 and an eighth path node 504c8 includes a first sequence of nodes including the fifth edge node 508c5, a ninth path node 504c9, and the eighth path node 504c8. The first network path is included in a second network path communicatively coupling the fifth edge node 508c5 and the second edge node 508c2 that includes a second sequence of nodes including of the nodes in the first sequence, a seventh path node 504c7, and the second edge node 508c2. A network path may be a physical network path or a logical network path based on a particular network protocol defining protocol endpoints in the path end nodes.

In various contexts, nodes illustrated as destination nodes 506, edge nodes 508, and/or path nodes 504 may operate as source nodes; and nodes illustrated as source nodes 502, edge nodes, 508, and/or path nodes 504 may operate as destination nodes. Exemplary nodes that may operate as path nodes 504 include a router, a switch, a wireless access point, a bridge, a gateway, and the like.

A path node 504 illustrated in any of FIGS. 5A-C and/or a node otherwise operating as a path node may include and/or may be included in an adaptation, analog, and/or instance of any execution environment 401 illustrated in FIG. 4A and FIG. 4B. A path node 504 may include a first network interface component and a second network interface component. With respect to FIG. 5B, a first path node 504b1 may be operatively coupled to a first network 512b1 included in a network 500b via a first network interface. The first path node 504b1 may be operatively coupled to a second network 512b2 via a second network interface. The first path node 504b1 may forward data sent from a source node 502b in the first network 512b1 to deliver via a second network 512b2 to a destination node 506b in a third network 512b3. The first network 512b1, the second network 512b2, and/or the third network 512b3 may respectively include and/or may be included in a local area network (LAN), an intranet, at least a portion of the Internet, and/or another wide area network (WAN).

Network components in some nodes may be configured according to a layered design or architecture known to those skilled in the art as a “network stack”. Adaptations, analogs, and/or instances of execution environments 401 in FIG. 4A and FIG. 4B may include network components in a layered architecture, physically and/or logically. Other architectural models for network components may be included in other execution environments to send and/or receive data via a network, and are considered within the scope of the subject matter described herein. Combinations of layered architectures and non-layered architectures are also considered to be within the scope of the subject matter described herein.

Some components illustrated in FIG. 4A correspond to components of the layered architecture specified by the Open System Interconnection (OSI) model, known to those skilled in the art. For example, network components in FIG. 4A may comply with specifications for protocols included in the TCP/IP protocol suite. The OSI model specifies a seven-layer stack. The TCP/IP protocol suite may be mapped to layers three and four of the seven layers. Those skilled in the art will understand that fewer or more layers may be included in various adaptations, analogs, and/or instances of execution environments 401 illustrated in FIG. 4A, FIG. 4B; and for any other execution environment suitable to host an adaptation and/or analog of the arrangement of components illustrated in FIG. 3.

FIG. 4A illustrates a network layer component 403a that operates according to and/or otherwise corresponds to layer three of the open systems interconnection reference (OSI) model. The Internet Protocol (IP) is an exemplary layer 3 protocol, also referred to as a network layer protocol. FIG. 4A illustrates a first NIC 405a1 that may operatively couple a node including an adaptation, analog, and/or instance of the execution environment 401a to a network. One or more NICs 405a may operate according to and/or otherwise correspond to layer one, also known as the physical layer, of the OSI model, to receive and send signals via a physical data transmission medium.

FIG. 4A also illustrates a link layer component 407a that operates according to and/or otherwise corresponds to layer two, also known as the link layer, of the OSI model, for communicating, via layer one, between nodes sharing a physical data transmission medium, such as nodes in a LAN. Exemplary link layer protocols include an Ethernet protocol, a Token-ring protocol, and asynchronous transfer mode (ATM) protocol—to name a few. Some or all of the link layer component 407a may be included in one or more NICs. Some or all of a link layer component may be external to and operatively coupled to one or more NICs. An external portion may be realized, at least in part, as a device driver for the one or more NICs. Exemplary physical data transmission media include Ethernet cables of various types, co-axial cables, fiber optic cables, and media suitable for transporting various types of wireless signals.

The network layer component 403a, illustrated in FIG. 4A, may operate to communicate across various types of link layer protocols, in various adaptations. Layer three protocols enable data to be exchanged between and among nodes on different networks across different types of physical data transmission media and differing link layer protocols. The Internet Protocol (IP) in the TCP/IP protocol is the most widely utilized network layer protocol currently in use. For ease of illustration, the description that follows provides examples based on IP networks and protocols in the TCP/IP suite due to their wide use and because they are well known in the art. Those skilled in the art will understand that the scope of the subject matter described is not limited to IP networks.

Data may be received by an in-data handler component 409a to transmit to another node from an application (not shown) operating in the execution environment 401a. The data may be provided to the in-data handler component 409a directly from the application and/or indirectly via one or more higher layer protocol components. For example, the application may interoperate with a sockets component, known to those skilled in the art, to open a socket to access a protocol endpoint of the transmission control protocol (the TCP) and/or to access a protocol endpoint of the user datagram program (UDP).

In an aspect, the in-data handler component 409a may buffer the data to transmit via an out-data handler component 411a. The out-data handler component 411a may retrieve and/or otherwise receive data from the in-data handler component 409a and package the data in one or more data units of the network layer protocol of the network layer component 403a. The out-data handler component 411a may identify a network interface to transmit the data based on address information included in the one or more data units. The out-data handler component 411a may provide the one or more data units to the link layer component 407a to package the network layer data units in one or more link layer data units. The link layer component 407a may interoperate with one or more NICs 405a that are included in the network interface identified by the out-data handler component 411a.

In another aspect, an in-data handler component 409a in a path node 504 may receive a data unit including data sent from a source node 502 to an identified destination node 506. The data unit may be received by a NIC, such as a first NIC 405a1 in the path node 504. The NIC is included in a network path from the source node 502 to the path node 504. The data unit may be a link layer data unit provided to a link layer component 407a. The link layer component 407a may provide data in one or more link layer data units to the in-data handler component 409a. The in-data handler component 409a may to detect a network layer data unit in the data from the link layer component 407a. The data from the source node 502 may be received in one or more network layer data units.

The in-data handler component 409a may send address information detected in the one or more network layer data units to a routing agent component 413a included in the execution environment 401a for the path node 504. The routing component 413a may determine a next NIC 405a to relay the data received from the source node 502 in the one or more data units received via the first NIC 405a1.

The routing component 413a may interoperate with a forwarding component 415a to identify a next network interface to relay the data to the destination node 506. The forwarding component 415a may identify that a second NIC 405a2 is included in the next network interface, based on address information included in the one or more received data units. The forwarding component 415a may direct an out-data handler component 411a in the path node 504 to retrieve and/or otherwise receive the data from the in-data handler component 409a. The out-data handler component 411a may package the data in a network layer data unit and transmit the data unit via the link layer component 407a and the second NIC 405a2 as described above.

In addition to the protocols described above, protocols corresponding to layers in the OSI model above the network layer may be included in communicating via a network. The term “application protocol” as used herein refers to any protocol or combination of protocols that correspond to one or more layers in the OSI reference model above the network layer. Programs and executables, operating in respective execution environments 401, may communicate via one or more application protocols. Exemplary application protocols include the transmission control protocol (the TCP) in the TCP/IP suite, the user datagram protocol (UDP) in the TCP/IP suite, various versions of hypertext transfer protocol (HTTP), various remote procedure call (RPC) protocols, various instant messaging protocols, various email protocols, and various other protocols for real-time communications.

Data exchanged between nodes in a network may be exchanged via data units of one or more network protocols. An execution environment may include layer specific protocol components respectively configured according to the one or more network protocols. Some protocols and/or protocol components may define and/or provide services from multiple layers of the OSI model layer such as the Systems Network Architecture (SNA) protocol.

In addition to explicitly and/or implicitly specifying schemas defining valid data units, a network protocol may define and/or otherwise be associated with a defined identifier space to identify protocol endpoints defined according to the network protocol. The terms “identifier space” and “address space” are used interchangeably herein. For example, various versions of hypertext transfer protocol (HTTP) specify a format for HTTP uniform resource locators (URL). HTTP specifies a location in an HTTP header that identifies a URL as an identifier or address from the HTTP address space that identifies both a resource and recipient of an HTTP data unit. The transmission control protocol (TCP) specifies a format and vocabulary for a TCP header including a destination protocol endpoint identifier field referred to as a destination port number that, when combined with a destination protocol address from an IP packet, identifies a transport layer protocol endpoint of a receiver of data sent in a TCP data unit via a network. A source protocol endpoint is similarly identified by a source port number, included in a TCP header as defined by the TCP, along with a source protocol address from an IP data unit as defined by the Internet Protocol.

Other exemplary address spaces that identify protocol endpoints in various network protocols include an email address space, a telephone number address space for various telephony protocols, instant message address spaces for various instant message protocols, and media access control (MAC) addresses for various link layer protocols—to name just a few examples.

In delivering data via a network between protocol endpoints of a particular network protocol, addresses from address spaces of the various protocols at the various layers are typically translated and/or otherwise mapped between the various layers. For example, a unicast IP address in an IP packet is mapped to a link layer address. The IP packet is transmitted to a link layer protocol endpoint identified by the link layer address. The link layer protocol endpoint is in a node in a network path to transmit the data, via one or more IP packets, from a source node 502 to an identified destination node 506. Addresses at the various layers are assigned from suitable address spaces for respective corresponding network protocols.

FIG. 4B illustrates another exemplary execution environment 401b that may be included in a path node 504 illustrated in FIGS. 5A-C. In FIG. 4B, the execution environment 401b includes line card components 417b that respectively include NICs 405b. A first NIC 405b1 may operatively couple a current path node 504 with respect to data from a source node 502 to a previous network path with respect to data from the source node 502 to relay to a destination node 506. A second NIC 405b2 may operatively couple the path node 504 to a next network path with respect to the data from the source node 502.

Data sent from a source node 502 to deliver to an identified destination node 506 may be received in a data unit of a network protocol by a NIC of a path node 504, such as the first NIC 405b1. The data may be detected by an in-data handler (IDH) component 409b1 operatively coupled to the first NIC 405b1. The in-data handler component 409b1 may send address information received in the data unit to a routing agent (RA) component 413b1. RA components 413b are functionally analogous to a routing component 413a included in some adaptations, analogs, and/or instances of the execution environment 401a. An RA component 413b may determine a next NIC 405b to relay data received in a data unit via a previous NIC 405b.

The RA component 413b1 may interoperate with a forwarding agent (FA) component 415b1 to identify a second line card component 417b2 including a second NIC 405b2, based on the address information received in the data unit including data from the source node 502. FA components 415b are functionally analogous to forwarding components 415a that may be included in some adaptations, analogs, and/or instances of the execution environment 401a. The first FA component 415b1 may configure a switch interconnect unit (SIU) component 419b to provide a communication channel from the first line card component 417b1 to the second line card component 417b2 and vice versa, as needed. A line card component 417b may include a switch interface (SI) component 421b to write data to a channel configured in the SIU component 419b and/or to read data from a channel.

The first FA component 415b1 may setup a channel in the SIU component 419b to communicate the data from the source node 502 via a first SI component 421b1 to a second SI component 421b2 of the second line card component 417b2. The second SI component 421b2 may read the data communicated via the SIU component 419b and provide the data to a second out-data handler (ODH) component 411b2 in the second line card component 417b2 to transmit to the next node. The second ODH component 411b2 may package the data in one or more data units of the network protocol. The second out-data handler component 411b2 interoperates with the second NIC 405b2 to transmit the data via a data transmission medium to which the second NIC 405b2 is operatively coupled. Data may be relayed from the destination node 506 to the source node 502 in an analogous manner.

FIG. 5A illustrates that at least some path nodes 504, included in and/or providing an execution environments 401, may include more than one NIC 405, as illustrated by a second NIC 405a2 through an Nth NIC 405 an in FIG. 4A. Adaptations, analogs, and/or instances of the execution environment 401b in FIG. 4B may include more than the two line card components 417b and respective NICs 405b illustrated in the figure.

FIG. 5B, illustrates a number of network paths communicatively coupling the source node 502b and the destination node 506b in the network. One network path illustrated includes a sequence of hops including a first hop 510b1, a sixth hop 510b6, and a seventh hop 510b7. In FIG. 5C, the first network path described above communicatively coupling the fifth edge node 508c5 and the eighth path node 504c8 includes a first sequence of hops including a first hop 510c1 and a second hop 510c2.

Given the above definitions, note that the terms “network path” and “hop” may be defined in terms of network interfaces. In FIG. 5B, the network path described above communicatively coupling the source node 502b and the destination node 506b includes a sequence of network interfaces including a network interface in the first path node 504b1 in the first hop 510b1, a network interface in a second path 504b2 in a sixth hop 510b6, and network interface in the destination node 506b in a seventh hop 510b7. The network paths in FIG. 5C described above may also be described as a sequence of network interfaces.

In FIG. 5B, the first network 512b1 may represent a physical topology when the first network 512b1 represents a physical data transmission medium included in physically coupling nodes. The data transmission medium may be an Ethernet LAN, for example. The hops 510b in FIG. 5B may illustrate logical communicative couplings at a level of the network above the data transmission medium. The hops 510b may represent link layer hops, network layer hops or hops at some other layer of the network above the data transmission medium or physical layer.

With reference to FIG. 2, a block 202 illustrates that the method includes identifying a first hop identifier that is, for a first node in a network, an identifier of a first hop that includes a pair of consecutive nodes in a network path in the network. Accordingly, a system for determining a protocol address for a node includes means for identifying a first hop identifier that is, for a first node in a network, an identifier of a first hop that includes a pair of consecutive nodes in a network path in the network. For example, the arrangement illustrated in FIG. 3, includes a hop manager component 302 operable for and/or otherwise included in identifying a first hop identifier that is, for a first node in a network, an identifier of a first hop that includes a pair of consecutive nodes in a network path in the network.

FIG. 4A and FIG. 4B illustrate hop manager components 402 as adaptations and/or analogs of the hop manager component 302 in FIG. 3. One or more hop manager components 402 operate in an execution environment 401. In FIG. 4A, a hop manager component 402a is illustrated as a component of a network layer component 403a. In FIG. 4B, a hop manager component 402b is illustrated as a component of a line card component 417b.

In an aspect, hop information may be received in an exchange between a first node in a hop and one or more of a second node in the hop and a third node in the network. A hop may be detected in response to exchanging and/or otherwise receiving the hop information. In another aspect, hop information may be received in response to detecting a hop. With respect to FIG. 4B and FIG. 5A, a hop manager component 402b1 operating in a first line card in a first path node 504a1 may receive hop information via a first network interface that includes a first NIC 405b1. The first NIC 405b1 is included in a first hop 510a1 that includes a second path node 504a2. The first hop 510a1 may be a hop for a network protocol, such as a version of the internet protocol. The first path node 504a1 and the second path node 504a2 are illustrated in a sequence of nodes to transmit data sent from a source node 502a to a destination node 506a. Alternatively or additionally, the first hop manager 402b1 in the first path node 504a1 may receive hop information about the first hop 510a1 from any other node in the network 500a. For example, a third edge node 508a3 may include a network management application, such as a topology service or a portion thereof that collects and/or distributes network topology information for the network 500a representing nodes in the network that may include protocol endpoints for a specified network protocol. In still another aspect, hop information may be received by and/or otherwise in response to detecting a hop.

In FIG. 4B, a first hop manager 402b1 in the first path node 504a1 may receive hop information about the first hop 510a1 from NIC 405b1. NIC 405b1 may detect an operative coupling to a data transmission medium. The operative coupling may indicate that the NIC 405b1 may be included in one or more hops with one or more nodes operatively coupled to the data transmission medium. Further, hop information for a network protocol may be detected by detecting an active protocol end point, such as a TCP port, for the network protocol and/or any network protocol included in activating the protocol endpoint.

Hop information may be received in response to a user input detected by an input device. In an aspect, the hop information may be included in topology information that identifies a network topology or part of a network topology. In FIG. 5A, the third edge node 508a3 as described above may host a topology services that maintains network topology information. Such a node may be referred to as a topology node. Some or all of the network topology information may be received via an input device in response to a user input. A user may provide, via one or more input devices, hop information that identifies one or more of the first path node 504a1, the second path node 504a2, and a communicative relationship that identifies the first hop 510a1. A hop manager 402b operating in the first path node 504a1 and/or a hop manager 402b operating in the second path node 504a2 may receive hop information provided in response to user input.

A hop including a pair of nodes may include a first network interface in a first node in the pair and a second network interface in a second node in the pair. The first path node 504a1 as described above may include a first network interface that includes a first NIC 405b1. The second path node 504a2 may be and/or may include an adaptation, analog, and/or instance of the execution environment 401b and may include a second NIC 405b2. The first hop 510a1 may include the first NIC 405b1 in the first path node 504a1 and the second NIC 405b2 in the second path node 504a2. The first NIC and the second NIC may be included in communicatively coupling the first path node 504a1 and the second path node 504a2.

A network interface may include one or more network interface components. The network interface components may be included in a same hop. FIG. 5A illustrates a first edge node 508a1 that may be and/or may include an adaptation, analog, and/or instance of the execution environment 401a in FIG. 4A. The first edge node 508a1 may be operatively coupled to the network 500a via a first network interface component 405a1 and via a second network interface component 405a2. The first NIC 405a1 and the second NIC 405a2 may be associated with a shared protocol address, such as an internet protocol address. Data units of the network protocol may be received by either NIC 405a. A network interface in the first edge node 508a1 may be defined to include both NICs 405a. A hop including the first edge node 508a1 and a second edge node 508a2 may include both NICs in the network interface in the first edge node 508a1.

In another, aspect, a first node may be included in a first hop that includes a second node via a first network interface and the first node may be included in a second hop that includes the second node via a second network interface. In FIG. 5A, the first edge node 508a1 may include a first network interface that includes the first NIC 405a1 and a second network interface that includes the second NIC 405a2. The two NICs may be associated with different internet protocol addresses. Data units including one of the IP addresses are processed by one of the NICs and data units including the other IP address are processed by the other NIC. The first edge node 508a1 and the second edge node 508a2 may be included in a hop via the first NIC 405a1 in the first edge node 508a1. The first edge node 508a1 and the second edge node 508a2 may be included in a different hop via the second NIC 405a2 in the first edge node 508a1.

A first node may be included in a first hop along with a second node. The first node may be included in the first hop via a first network interface in the first node. The first node may be included in a second hop including a third node. The first node may be included in the second hop via a second network interface in the first node. As described with respect to FIG. 5A, the first hop 510a1 includes the first network interface in the first path node 504a1 and a second network interface in the second path node 504a2 illustrating a pair of consecutive nodes in the network path to transmit data between the source node 502a to the destination node 506a. The first network interface in the first hop is included in communicatively coupling the first path node 504a1 to the second path node 504a2 in the first hop 510a1. FIG. 5A illustrates the first path node 504a1 is included in a second hop 510a2 including the source node 502a. The first path node 504a1 is included in the second hop via a second network interface in the first path node 504a1.

A first node and a second node may be included in a first hop in a first network path from a source node to a destination node. The first node may be included in the first hop via a first network interface in the first node included in communicatively coupling the first node and the second node. The first node and the second node may be included in a second hop in a second network path from the source node to the destination node. The first node may be included in the second hop via a second network interface in the first node included in communicatively coupling the first node and the second node. Referring again to FIG. 5A, a third path node 504a3 and a fourth path node 504a4 are included in a third hop 510a3 in a first network path including a first sequence of hops between the source node 502a and the destination node 506a. The third path node 504a3 may be included in the third hop 510a3 via the first network interface in the third path node 504a3. The third path node 504a3 and the fourth path node 504a4 are included in a fourth hop 510a4 illustrated in FIG. 5A. The fourth hop 510a4 may be included in a second network path including a second sequence of hops between the source node 502a and the destination node 506a. The third path node 504a3 may be included in the fourth hop 510a via second network interface in the third path node 504a3.

Hop information for a hop may be exchanged and/or received in response to detecting a change in a state of an operable coupling between a network and a network interface included in the hop and included in a node in the hop. Detecting the change may include detecting that the state indicates that the operable coupling is inoperative and subsequently detecting that the state indicates the operable coupling is operative. Detecting the change may include detecting that the state indicates that the operable coupling is operative and subsequently detecting that the state indicates the operable coupling is inoperative. In FIG. 4B, a first hop manager component 402b1 operating in a first path node 504b1 may monitor activity of a network interface including the first line card 417b1 coupled to a first network 512b1 in the network 500b. The first hop manager 402b1 may monitor one or more components of the first line card 417b1. In an aspect, the first hop manager component 402b1 may monitor whether data is received and/or transmitted via the first line card 417b1. The first hop manager component 402b1 may interoperate with the first IDH component 409b1 and the first ODH component 411b1.

A hop manager component 402a operating in the source node 502b in FIG. 5B may similarly monitor data sent and/or received via a first NIC 405a1 coupling the source node 502b to the first network 512b1. Alternatively or additionally, the hop manager component 402a may monitor an attribute of a network interface, such as power used by and/or available to the first NIC 405a1. The first path node 504b1 may include hop manager components 402b, as illustrated in FIG. 4B, that may monitor an SI component 421b and/or an SIU component 419b to determine whether a line card 417b in a particular network interface is exchanging data with another line card 417b in another network interface in the first path node 504b2.

One or more criteria may determine whether a network interface is operative or inoperative. In the first path node 504b1, a criterion measuring data exchanged by a line card 417b with another line card in the first path node 504b1 may establish a length of time. The first hop manager component 402b1 may detect that a network interface that includes the first line card 417b1 is operatively coupled to the network 500b by detecting that data exchanged between the first line card 417b1 and another line card in the first path node 504b2 in a time period having a length less than the specified length in the criterion. When no data is detected by the first hop manager component 402b1 in a time period with a duration greater than or equal to the length specified in the criterion, the first hop manager component 402b1 may determine that the network interface is inoperative. When more than one NIC is included in a network interface, a hop manager may determine whether a criterion is met for one or more of the NICs in determining whether the network interface is operative or inoperative.

A hop manager component may monitor one or more operations included in sending data and/or receiving data via a coupling including a network and a network interface. In an aspect, the hop manager component 402a in the source node 502b in FIG. 5B may send and/or receive data via a network interface to detect whether the network interface is operative or inoperative. The network interface may be included in the source node 502b. The network interface may be in another node included in exchanging data with the source node 502b. The hop manager component 402a in the source node 502b may send a data unit to the first hop manager component 402b1 in the first path node 504b1 that may to detect whether a network interface in the source node 502b and/or a network interface in the first path node 504a1 is operative or inoperative. As described, a hop manager may receive a message from another node indicating that a network interface in the other node is operative or inoperative.

A network protocol may be specified to exchange data between and/or among nodes that include hop manager components to determine whether certain network interfaces in the nodes are operative or inoperative. The protocol may include and/or be an extension of one more existing protocols such as the address resolution protocol (ARP), the dynamic host configuration protocol (DHCP), and/or any of numerous network protocols for announcing and/or detecting the presence of a node, a network interface, and/or other resource on a network. The hop information may be sent in a message to a DNS service, a topology service, a network management problem detection service, and/or to a web server—to name a few examples. The protocol may be a yet unspecified protocol to count network interfaces in a region of a network.

Hop information may identify an interface identifier that identifies at least one of a first network interface by which a first node is included in a hop and a second network interface by which a second node is included in the hop. In FIG. 5B, the hop manager component 402a in the source node 502b may send the identifier value 151 in hop information to the first path node 504b1 for the first hop 510b1. The first hop may be based on a network layer protocol operating via link or physical layer shown by the first network 512b1. The source node 502b may assign the value 151 as an identifier for the first network interface in the source node 502b according to the network protocol. Alternatively or additionally, the first hop manager 402b1 in the first path node 504b1 may include and/or otherwise identify the value 1 as an interface identifier in hop information sent to the source node 502b and/to another node in the network 500b. The value 1 may be assigned to identify a second network interface in the first path node 504b1 that includes the first line card 417b1 for the network protocol of the first hop 510b1.

An interface identifier included in hop information for a hop including a pair of nodes may be specified according to the requirements of a network protocol. The network protocol may be a network layer protocol, such the IPv4 and/or IPv6 protocols. The interface identifier may identify at least one node in a hop to the other. The interface identifier may be suitable to include in a data unit of a network protocol to transmit data in the data unit between the nodes in the hop. Hop information for a hop may be exchanged in more than one communication sent and/or received by a node in the hop. Hop information may be exchanged in a negotiation to determine a hop identifier for the hop. For example, a pair of nodes in a hop may each have a criterion to be met by a shared hop identifier. One or more of the nodes may suggest hop identifiers until a hop identifier that meets the criteria of both nodes is suggested. Alternatively or additionally, the nodes may exchange criterion information.

A hop manager component 402 may store a hop identifier criterion in a data storage medium accessible in and/or to a node. Alternatively or additionally, criterion information including a hop identifier criterion and/or otherwise included in identifying a hop identifier criterion may be received by a hop manager component 402 from a user via an input device and/or may be received via a network. In an aspect, hop information may include and/or may be included in identifying a hop identifier criterion.

In an aspect, a hop identifier criterion may specify a particular hop identifier to identify a hop and/or a portion of the particular hop identifier. That is, a hop identifier criterion may specify a hop identifier or part of a hop identifier. As described above, in FIG. 5B, one or both of the source node 502b and the first path node 504b1 may send hop information identifying an interface identifier of network interface included in the first hop 510b1. A hop manager component 402a in the source node 502b may determine a hop identifier that includes one or both of the interface identifiers as described below in more detail. In FIG. 5C, a hop manager component 402b1 in a second path node 504c2 may receive a hop identifier criterion that identifies the value 1 as a hop identifier for a third hop 510c3. For a specified network protocol, the value 1 may serve to identify the second path node 504c2 to the fourth path node 504c4. Alternatively or additionally, the value 1 may serve to identify the fourth path node 504c2 to the second path node 504c4. A hop identifier criterion may specify and/or may be evaluated based on an interface identifier of a network interface included in a hop.

Determining a hop identifier for a hop may include determining the hop identifier based on an interface identifier that identifies at least one network interface in the hop. The interface identifier may identify at least one of a first network interface in a first node in the hop and a second network interface in a second node in the hop to at least one of the first node and the second node.

A hop identifier for a hop may be based on a first interface identifier that identifies a first network interface in a first node in the hop and/or may be based on a second interface identifier that identifies a second network interface in a second node in the hop. The first interface identifier may identify the first network interface to one or both of the nodes in the hop. The second interface identifier may identify the second network interface to at least one of the first node and the second node. The hop identifier may include the first interface identifier and/or the second interface identifier.

Returning to FIG. 5B, hop manager component 402a in the source node 502b may determine a hop identifier for the first hop 510b1 that includes the interface identifier with the illustrated value 151 and the interface identifier with the illustrated value 1. The hop identifier identifying the first hop 510b1 may be represented as 151-1. Hop manager component 402a may determine and/or otherwise identify the hop identifier based on the hop information identifying the two interface identifiers and based on a criterion that identifies a schema for a hop identifier that defines a format for a hop identifier that includes a pair of interface identifiers. The hop manager component 402a in the first node may send the hop identifier to the first path node 504b1 in hop information. A hop manager component 402b may determine the hop identifier represented by 151-1 to be an identifier for the first hop 510b1 based on the hop information, from the source node 502b, that includes the hop identifier. The hop manager component 402b in the first line card 417b1 may determine that the hop identifier meets a criterion. The criterion may be based on the schema.

Returning to FIG. 5C, a hop manager component 402b in the fourth path node 504c4 may determine a hop identifier represented in text as 1 to identify the third hop 510c3. A hop identifier for a hop that includes a pair of nodes may be based on a network interface that is in a node in the pair and that is not included in the hop. A hop manager component 402b in the fourth path node 504c4 may determine that a criterion that specifies that hop identifiers for hops that include the fourth path node 504c4 must each have different values. FIG. 5C illustrates the fourth path node 504c4 included in a fourth hop 510c4 with a hop identifier assigned the value 2, and in a fifth hop 510c5 with a hop identifier of 3. The hop manager component 402b in the fourth path node 504c4 may determine that the value 1 meets the criterion for the third hop 510c3. In response to determining the hop identifier 1 to identify the third hop 510c3, a hop manager component 402a in the fourth path node 504c4 may send hop information that identifies the value 1 to the second path node 504c2. The second path node 504c2 may receive the hop information as described above.

A hop identifier for a hop including a first node and second node may serve to identify the first node to the second node and/or may serve to identify the second node to the first node. For a specified network protocol, the value 1 assigned to the third hop 510c3 may serve to identify the second path node 504c2 to the fourth path node 504c4. Alternatively or additionally, the identifier assigned to the third hop 510c3 may serve to identify the fourth path node 504c2 to the second path node 504c4.

A hop may be identified by a hop identifier that includes a first interface identifier for a first network interface in a first node in the hop and that includes a second interface identifier for a second network interface in a second node in the hop. The hop identifier may identify the first node with respect to the second node based on a first ordering of the first interface identifier and the second interface identifier. The hop identifier may identify the second node with respect to the first node based on a second ordering of the first interface identifier and the second interface identifier. With respect to FIG. 5B the identifier 151-1 described above as an exemplary hop identifier for the first hop 510b1 may, in the first hop 510b1, identify the first path node 504b1 when the interface identifiers are ordered as 151 followed by 1. The hop identifier may, in the first hop 510b1, identify the source node 502b when the interface identifiers are ordered as 1 followed by 151.

Determining that a hop identifier meets an identified hop identifier criterion may include determining that the hop identifier is the smallest, available hop identifier in an identifier space of hop identifiers. In FIG. 5C, a sixth path node 504c6 may be and/or may include an adaptation, analog, and/or instance of the execution environment 401b in FIG. 4B. The sixth path node 504c6 may be included in a sixth hop 510c6 having a hop identifier value of 0 and may be included in a seventh hop 510c7 having a hop identifier value of 1. A hop manager component 402b may receive a message from a fourth edge node 508c4 including hop information suggesting the hop identifier 0. The hop manager 402b may provide the hop information to a hop manager component 402b in the sixth path node 504c6 to determine a hop identifier for an eighth hop 510c8 that includes the sixth path node 504c6 and the fourth edge node 508c4 for a network protocol, such as a version of the internet protocol. The hop manager component 402b interoperating with the hop manager component 402b may determine that the smallest available hop identifier is 2 for the sixth path node 504c6. The hop manager component 402b may interoperate with the hop manager component 402b to send the hop identifier 2 in hop information to the fourth edge node 508c4 to negotiate the hop identifier value and determine the hop identifier value for the eighth hop 510c8 to be 2. As described above, hop information may be exchanged in a negotiation to determine a hop identifier for a hop.

Determining that a hop identifier meets an identified hop identifier criterion may include identifying a threshold condition that is based on the hop identifier criterion. The determining may further include detecting that the threshold condition is met by the hop identifier. The hop identifier may be determined in response to detecting that the threshold condition is met. A threshold condition may be evaluated based on a count of network interfaces included in one or more nodes in a hop, a size of a location in a data storage medium to store a hop identifier, a size of a representation of a hop identifier in a signal propagated by a specified data transmission medium, a size of a hop identifier included in a protocol address in a data unit that is valid according to a network protocol, and/or a time period to process a hop identifier included in a protocol address, to name a few examples.

With respect to a time period to process a hop identifier, processing may be performed by one or more components included in sending, receiving, and/or relaying data in a data unit that is valid according to a network protocol. In an aspect, processing may include identifying a first network interface in a first node in the hop, based on the first hop identifier. The first network interface may be identified to forward the data to a destination node identified in the data unit via a second node in the hop. For example, a hop identifier criterion may be specified for a router. In FIG. 5A, the fourth path node 504a4 may be and/or may include a router device. A hop identifier criterion may be specified to identify hop identifiers to minimize processing time in determining a network interface to relay data to a next node in a network path between the source node 502a that sent the data and the destination node 506a identified as the recipient of the data. Matching a hop identifier with an interface identifier that are both represented as integers that may be represented in a register of a processor in the first path node 504a1 may require less processing time that looking up a version 4 or a version 6 internet protocol address and mapping the internet protocol address to a MAC address for a NIC that is represented in hexadecimal by a twelve digit number which when represented in base two may be larger than the word size of the processor. As a result, a hop manager component 402b in the fourth path node 504a1 may assign its respective network interfaces 0, 1, 2, and 3. The fourth path node 504b1 may provide the hop identifiers in hop information to other nodes. For example, the fourth path node 504b1 may provide the interface identifier 0 to destination node 506a. A hop manager component 402a in destination node may receive the hop identifier in hop information. The hop manager 402a in destination node 506a may provide the interface identifier 0 to a hop manager component 402a, which may assign a hop identifier of 0 to a hop 510a6 that includes the destination node 506b and the fourth path node 504a4. Destination node 506a may in a similar manner assign an identifier of 2 to its network interface based on interface identifiers already assigned for a third path node and a third edge node that are also included in hops with the fourth path node 504a4. The fourth path node 504a4 may receive hop information from destination node that identifies 2 as destination node's 506a interface identifier. A hop manager component 402b in the fourth path node may assign 2 as a hop identifier for the sixth hop 510a6.

A hop identifier criterion may specify and/or otherwise identify some or all of a schema that defines a valid format and/or a valid vocabulary for a representation of a hop identifier when included in a protocol address identifying a protocol endpoint of a network protocol. In an aspect, the schema may specify and/or otherwise identify a format rule defining a valid size of the representation in the protocol address included in a data unit of the network protocol. A size specified by a schema may identify a maximum size for a representation of a hop identifier. A size specified by a schema may identify a minimum size for a representation of a hop identifier. A size may identify an optimum or preferred size, based on a specified criterion, for a representation of a hop identifier. A size specified by a schema may identify a maximum size for an interface identifier included in a hop identifier. A size specified by a schema may identify a minimum size for an interface identifier included in a hop identifier. A size may identify an optimum or preferred size, based on a specified criterion, for an interface identifier included in a hop identifier.

Schemas explicitly and/or implicitly define rules for a valid format of an interface identifier and/or rules defining a vocabulary to define valid content of a representation of an interface identifier. A rule may define a constraint on the format or structure of an interface identifier and/or a constraint on the content of an interface identifier. A threshold condition may be specified by and/or otherwise based on a schema defining a valid protocol address to identify a protocol endpoint for a particular network protocol.

A hop identifier may be based on one of more network interfaces in nodes in the hop. More generally a hop identifier may be based on one or more network interface in one more nodes for which a hop identifier servers to identify a particular hope. In FIG. 5A, a hop identifier may identify the first hop 510a for the third edge node 508a3. FIG. 5A illustrates that a hop identifier based on network interfaces in the third edge node 508a3, the fourth path node 504a4, the third path node 504a3, the second path node 504a2, and/or the first path node 504a1 may be included in various hop identifiers for the first hop 510a1 for the third edge node 508a3. Examples of such hop identifiers in FIG. 5A include the hop identifier 1 . . . 3.0.0, and the hop identifier 0-1.3-1.2-0.2-0. Thus, with respect to the method in FIG. 2 the first hop identifier may be identified based on one or more of a first network interface in the first node and a second network interface in a node in the first hop, and/or a network interface in a node in a network path that from the first node to the node a node in the first hop. Further, with respect to the method in FIG. 2, the first hop identifier may include a path identifier that identifies a network path included in communicatively coupling the first node to a node in the first hop. The first hop identifier of FIG. 2 may include a protocol address for the network protocol that at least one of identifies the first node to a node in the hop and identifies a node in the hop to the first node.

Returning to FIG. 2, block 204 illustrates that the method further includes receiving a first protocol address that for a network protocol at least one of identifies the first node to a second node in the network and identifies the second node to the first node, wherein the second node is not in the first hop. Accordingly, a system for determining a protocol address for a node includes means for receiving a first protocol address that for a network protocol at least one of identifies the first node to a second node in the network and identifies the second node to the first node, wherein the second node is not in the first hop. For example, the arrangement illustrated in FIG. 3, includes an address space director component 304 operable for and/or otherwise included in receiving a first protocol address that for a network protocol at least one of identifies the first node to a second node in the network and identifies the second node to the first node, wherein the second node is not in the first hop.

FIG. 4A and FIG. 4B illustrate address space director (ASD) components 404 as adaptations and/or analogs of the address space director component 304 in FIG. 3. One or more address space director components 404 operate in an execution environment 401. In FIG. 4A, an address space director component 404a is illustrated as a component of a network layer component 403a. In FIG. 4B, an address space director component 404b is illustrated as component of a line card component 417b.

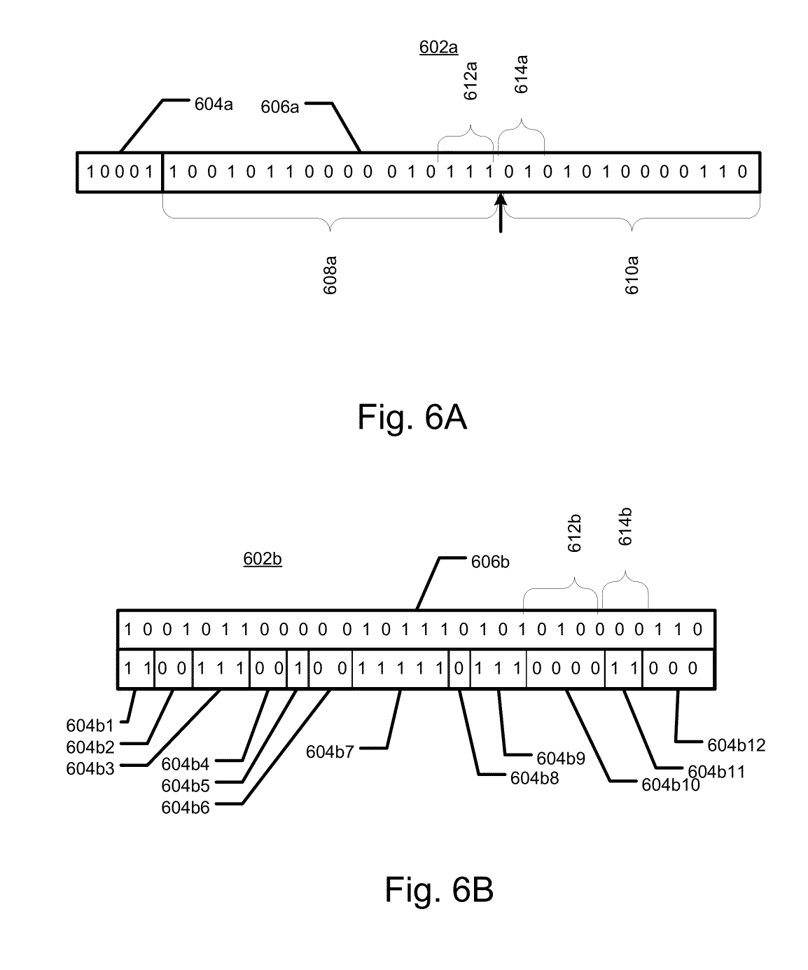

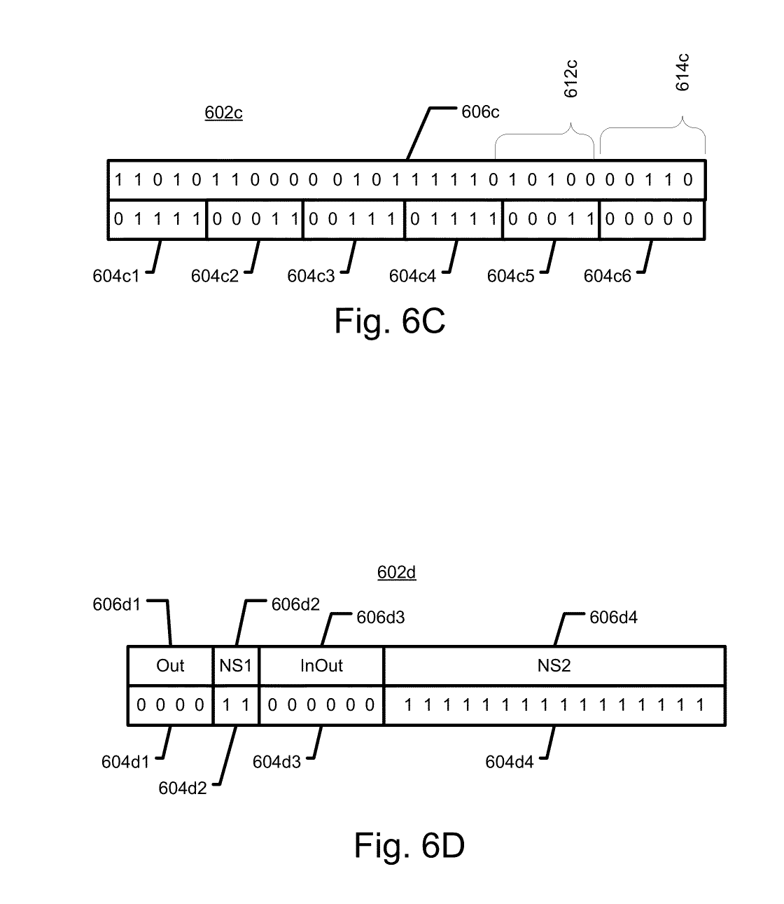

FIGS. 6A-D illustrate a number of types of address representations 602 illustrating aspects of various address formats and vocabularies to represent protocol addresses for some existing protocols as well as protocols yet to be defined. Protocol addresses that may be identified in address representations 602 may include and/or otherwise may be based on path identifiers, hop identifiers, interface identifiers, scoped addresses of various sorts, metric space based addresses, and/or scope-specific addresses of various sorts. The respective address representations 602 are illustrated including portions that are contiguous, but need not be so in various embodiments. Additionally, the content of any illustrated portion need not be contiguous.

The address representations 602 in FIGS. 6A-D may be identified based on a rule for a format of a data unit and/or a rule for a vocabulary of a data unit as defined by a schema or specification for a network protocol. For example, an address type field in an IPv6 packet may include a bit pattern that may be defined to identify any of the types of address representations within the scope of this disclosure as a new IP address type. Thus, IPv6 may be extended to include one or more of the address representation types and/or their analogs as valid IP addresses. Address representations 602 in FIGS. 6A-D are described with respect to their use in data units of a network protocol. Each of the address types shown in FIGS. 6A-D may be included in a destination protocol address portion and/or a source protocol address portion of an IPv4 data unit header and/or of an IPv6 data unit header. The representations described herein, their adaptations, and/or their analogs may be included in address spaces of other network protocols. For example, media access control (MAC) addresses that serve as protocol addresses for various link layer protocols may be replaced with any of a number of the various adaptations, analogs, and address representations 602 or portions thereof illustrated in FIGS. 6A-D and described herein. HTTP URLs may include host identifiers based on any of the address representations within the scope of this disclosure.

Address representations 602 may be detected and/or otherwise recognized by one or more components that operate according to a network protocol, such as components of a network layer component 403a in FIG. 4A and various components in FIG. 4B. As described above, a particular address representation may be detected and/or otherwise identified based on a bit pattern or identifier defined to identify a particular type of address representation. RFC 3513 specifies type bits in an IP data packet header to identify and/or otherwise detect a type of address represented in a destination address field and/or in a source address field. A bit pattern or identifier may be located by a component, such as an IDH component 409 in various adaptations of the execution environments 401 in FIG. 4A and in FIG. 4B. Those skilled in the art will realize that neither the schemas described, which define a format rule(s) and/or a vocabulary rule(s) for a protocol address, nor the network protocols in which their use is described are exhaustive.

FIG. 6A illustrates an address representation 602a that may be included in a data unit or packet of an Internet Protocol or other network protocol. An address representation 602a may identify one or both of a source address and a destination address respectively identifying a source node 502 and a destination node 506. In an aspect, an address representation 602a may be processed as including at least three portions. An address separator field 604a is illustrated including a binary number. In FIG. 6A, the binary number illustrated equals seventeen in base ten. The number in the address separator field 604a identifies the size in an address information field 606a of a previous address field 608a to identify the previous address field 608a and a next address field 610a.

A router component 413 and/or an address space director component 404, in a current node, may process information in a previous address field 608a to identify a previous address that identifies the current node to a previous node. A router component 413 and/or an address space director component 404 may identify, based on information in a next address field 610a, a next protocol address that identifies a next node in the network path to the current node.

Alternatively or additionally, a router component 413 and/or an address space director component 404 may identify, based on information in a next address field 610a, a current protocol address that identifies the current node to a next node. A router component 413 and/or an address space director component 404 interoperating with an in-data handler component 409 may determine a next protocol address that identifies the next node to the current node. In another aspect, router component 413 and/or an address space director component 404 may determine the current address based on the next protocol address.

Additionally, a current node may detect a previous hop identifier field 612a including a hop identifier that identifies a hop that includes the current node and a previous node. The current node may also detect a next hop identifier field 614a that includes a hop identifier that identifies a next hop including the current node and a next node in a network path to a destination node.

With respect to FIG. 5A, an address representation 602a may be included in a data unit including data from a source node 502a to transmit to a third edge node 508a3. FIG. 5A illustrates, the sequence of hops including the second hop 510a2, the first hop 510a1, a fifth hop 510a5, the third hop 510a3, and a seventh hop 510a7 that are included in a network path from the source node 502a to the third edge node 508a3. Hop identifiers may include interface identifiers of network interfaces included in the respective identified hops as described above. The sequence of identifiers 1.2.2.2.0, illustrated in FIG. 5A, may be represented in an address information field 606a to identify a protocol address that identifies the third edge node 508a3 with respect to the source node 502a.

At the source node 502a, the address separator field 604a may be set to include a size of zero for a previous address field 608a. The address information field 606a, thus, includes a next address field 610a at the source node 502a and identifies the third edge node 508a3 with respect to nodes in the first region 510a1. A next hop field may identify the second hop 510a2 to transmit the data to the first path node 504a1 in the network path.

At a first path node 504a1, an address separator field 604a in a data unit including the data from the source node 502a, may include a value that identifies, in a previous address field 608a that includes of the previous hop field 612a, the second hop identifier 510a2. A router component 413 in the first path node 504a1 may detect the value. The router component 413 may also identify, based on the value in the address separator field 604a, a next address field 610a that identifies 2.2.2.0 as a next protocol address that identifies the third edge node 508a3 and a next hop field 614a identifies the first hop 510a1 as the next hop in the network path to transmit data received from the source node 502a.

At the third edge node 508a3 a data unit including the data from the source node 502a may include a value in an address separator field 604a that indicates that the address information field includes only a previous address field 608a identifying 0.2.2.2.2, which is the destination protocol address when interpreted with the interface identifiers in the order written. The data unit received by the third edge node 508a3 may include an address representation 602a in a source address portion of the data unit according to the network protocol. The sequence of hop identifiers 1.3.0.0.0 may be included in the source address representation to identify the source node 502a to the third edge node 508a3.

FIG. 6B illustrates an address representation 602b identifying path information that may be detected by a router component 413 and/or by an address space director component 404. An address information field 606b may be interpreted as a network path identifier based on address separator field(s) 604b in a data unit. Address separator fields are specified according to a network protocol to distinguish one path identifier from another path identifier in an address information field 606b.

With respect to FIG. 6B, a router component 413, an address space director component 404, and/or an in-data handler component 409 may distinguish hop identifiers, since a single hop is a network path. A router component 413 may distinguish separate hop identifiers based on changes in values in bits of consecutive address separator fields 604b. In FIG. 6B, a first address separator field 604b1 includes one or more 1-valued bits that correspond to bit positions in the address information field 606b to identify a previous address field referred to in FIG. 6B as a first hop information field. Network paths that include more than one hop may be distinguished similarly as shown in FIG. 6B. Combinations of hop identifiers and path identifiers may be distinguished by a router component 413, an address space director component 404, and/or an in-data handler component 409 based on information in address separator fields 604. A second hop information field 604b2, in FIG. 6B, includes two 0-valued bits to identify a second hop information field in address information field 606b. Additional alternating sequences of 1-valued bits and 0-valued bits, illustrated by address separator fields 604b3-12c, correspond to and identify other hop information fields identifying hops in a network path communicatively coupling a source node 502 and a destination node 506.

Additionally, a current node may detect a previous hop identifier field 612b including a hop identifier that identifies a hop that includes the current node and a previous node. The current node may also detect a next hop identifier field 614b that includes a hop identifier that identifies a next hop including the current node and a next node in a network path to a destination node.

In FIG. 5C, a hop may be identified by an interface identifier that may identify directly and/or identify indirectly one or more network interfaces in a pair of communicatively coupled nodes included in the hop. For example, the number 2 may serve as a hop identifier for a ninth hop 510c9 that includes a fifth path node 504c5 along with a seventh path node 504c7. The number 2 may also identify a network path for exchanging data between the two nodes. The number 2 may also be and/or be included in a protocol address that identifies the sixth path node 504c6 with respect to an eighth path node 504c8 in an eighth hop 510c8. The number 2 may also identify the eighth path node 504c8 with respect to the sixth path node 504c6.

In FIG. 5C, the source node 502c may identify the seventh path node 504c7 by a destination protocol address that identifies a sequence of hops in a network path between the two nodes. The protocol address may be based on a sequence of hop identifiers, 101.0.1.3.2. Note that other network paths are illustrated that may communicatively couple the source node 502c and the seventh path node 504c7 to send data from the source node 502c to the seventh path node 504c7 and vice versa. The hop identifiers in a protocol address may meet different criteria as described above.

The hop identifiers, 101.0.1.3.2 may be represented in an address representation 602b in a data unit included in sending data from the source node 502c to the seventh path node 504c7. Note that the address information identifies one or more protocol addresses for the seventh path node 504c7. An address representation 602 may include information to identify a return path or a portion thereof. For example, the protocol address, 2.3.1.0.101, identifies the source node 502c to the seventh path node 504c7 in a data unit of a network protocol.

FIG. 6C includes an address representation 602c illustrating a schema for representing path information based on identifiers of hops included in a network path. A router component 413 and/or an in-data handler component 409 may operate based on the schema or a portion of the schema. An address information field 606c includes path information to identify a network path communicatively coupling a pair of path end nodes in the network path. FIG. 6C illustrates that an address representation 602c may include one or more address separator fields 604c that correspond to and/or otherwise identify one or more respective portions of the address information field 606c that are based on one or more pairs of identifiers of network interfaces that identify hops and/or network paths in a network. An address separator field 604b includes a series of 1-valued bits and a series of 0-valued bits. A change from a 1 value to a 0 value and vice versa in the series may indicate, to a router component 413 and/or an in-data handler component 409, a boundary separating interface identifiers. Since a network path may consist of a single hop, a pair of interface identifiers corresponding to an address separator portion 604b may identify network interfaces in a hop in a network path. An address separator field 604c1 includes one 0-valued bit followed by four 1-valued bits. The 0-valued bit may be defined to indicate that a first network interface in a first hop identifier is one bit long with a corresponding position in the address information field 606c. FIG. 6C identifies the first interface identifier as the number 1. The four 1-valued bits in the first address separator field 604c1 may be similarly defined to identify the location of a second interface identifier in the first hop identifier.

The second interface identifier, as illustrated in FIG. 6C, has the value 10 in base ten. The first hop identifier includes the numbers 1 and 10. A second hop identifier is located by the end of the series of four 1-valued bits in the first address separator field 604c1 to a series of three 0-valued bits that identify a boundary of a second address separator field 604c2 for second hop information identifying a second hop identifier, and the three 0-valued bits also identify the location of a first interface identifier in second hop information in the address information field 606c. Two subsequent 1-valued bits identify the location in the address field 606c of a second interface identifier in the second hop information. The second hop identifier includes the numbers 6 and 0 in base ten. The remaining address separator fields 604c may be processed similarly.

A current node may detect a previous hop identifier field 612c including a hop identifier that identifies a hop that includes the current node and a previous node. The current node may also detect a next hop identifier field 614c that includes a hop identifier that identifies a next hop including the current node and a next node in a network path to a destination node.

FIG. 6D illustrates an address representation 602d that may include portions that include path information, portions that include scoped protocol addresses, portions based on metric spaces, and/or portions that include scope-specific portions. A router component 413 may distinguish protocol address portions based on address separator fields 604d. Address separator fields 604d may be defined to identify protocol address portions in a manner similar to the method described for distinguishing hop identifiers in FIG. 6B. A previous address information field 606d1, in FIG. 6D, corresponding to a first address separator field 604d1 includes a single interface identifier for an outbound network interface for a source node 502. A next address information field 606d2 corresponding to a second address separator field 604d2 may include a scoped protocol address having an inside scope, an outside scope, or both. A node processing the second address information field 606d2 may be included in a portion of a network spanned by the scope of the scoped protocol address. The node may be configured to process the scoped protocol address accordingly. See application Ser. No. 11/962,285, by the present inventor, filed on 2007 Dec. 21, entitled “Methods and Systems for Sending Information to a Zone Included in an Internet Network” for a description of addresses having outside scope and/or inside scope and processing of such addresses. A third address information field 606d3 corresponding to a third address separator field 604d3 may include a pair of interface identifiers in a hop identifier as described with respect to FIG. 6C and with respect to FIG. 6A. A fourth address information field 606d4 corresponding to a fourth address separator field 604c4 may include a protocol address analogous to one of the types of addresses described with respect to the next address information field 606d2 such as an local-scoped address.

Note, in FIG. 5C, that the various nodes in the network path including and between the source node 502c and the destination node 506c have different network interface counts. As such, interface identifier spaces for the respective nodes and/or regions that include more than one node may have a different size or number of identifiers in their respective identifier spaces, different maximum sizes of numeric interface identifiers, different minimum sizes of storage space required to store a representation of an interface identifier, and/or other attributes that vary according to a measure of size. A threshold size may be determined and/or otherwise identified for one or more interface identifier related entities with attributes having a size. A hop identifier threshold size may specify a maximum size required by a maximum size hop identifier in a hop identifier address space. In another aspect, a hop location size may specify a maximum hop location size required by a particular hop identifier.

As described above and illustrated in FIGS. 6A-D, a protocol address may include one or more other protocol addresses. Thus, receiving a protocol address may include detecting the protocol address as a portion of another protocol address. Further, receiving a protocol address may include detecting the protocol address in a destination address field and/or in a source address field of a data unit of a network protocol, where the protocol address is included in an address space of the network protocol.

In yet another aspect, receiving a protocol address may include detecting the protocol address in a message transported by one or more data units of a network protocol, where the protocol address is included in an address space of the network protocol. For example, a protocol address may be included in a message sent to a DNS server, a topology service, a network management problem detection service, and/or to a web server—to name a few examples. The message may be transported in one or more data units of a network protocol that has an address space that includes the protocol address. For example, the message may be transported in one or more data units of the IP protocol, the TCP protocol, and/or a link layer protocol. The message may identify a symbolic identifier for at least one of a node in a hop, the hop, and/or a node not in the hop.

With respect to the method in claim 2, the first protocol address may identify a protocol endpoint, of the network protocol, in the first node to the second node and/or may identify a protocol endpoint, of the network protocol, in the second node to the first node

Returning to FIG. 2, a block 206 illustrates that the method yet further includes determining, based on the first protocol address and the first hop identifier, a second protocol address that for the network protocol at least one of identifies, to the second node, a node in the first hop that is not the first node and identifies the second node, to a node in the first hop, that is not the first node. Accordingly, a system for determining a protocol address for a node includes means for determining, based on the first protocol address and the first hop identifier, a second protocol address that for the network protocol at least one of identifies, to the second node, a node in the first hop that is not the first node and identifies the second node, to a node in the first hop, that is not the first node. For example, the arrangement illustrated in FIG. 3, includes an topology component 306 operable for and/or otherwise included in determining, based on the first protocol address and the first hop identifier, a second protocol address that for the network protocol at least one of identifies, to the second node, a node in the first hop that is not the first node and identifies the second node, to a node in the first hop, that is not the first node.

FIG. 4A and FIG. 4B illustrate topology components 406 as adaptations and/or analogs of the topology component 306 in FIG. 3. One or more topology components 406 operate in an execution environment 401. In FIG. 4A, a topology component 406a is illustrated as a component of a network layer component 403a. In FIG. 4B, a topology component 406b is illustrated as component of the execution environment 401b operatively coupled to an SIU component 419b.

With respect to FIG. 5A, an in-data handler component 409a in a third edge node 508a3 may receive a data unit and/or a message transmitted from a source node 502a. The data unit and/or the message identify a protocol address such as 1.2.2.3.0 and/or as 1.2.2.2.0, which identifies network interfaces in a network path from the source node 502a to the third edge node 508a3. The data unit may include the protocol address as a destination address. Alternatively or additionally, a source address in the data unit and/or a message may be based on one or more network interfaces in a network path from the third edge node 508a3 to the source node 502a. For example, a source protocol address may be represented as 1.1.0.0.0 and/or as or 1.3.0.0.0.

An in-data handler component 409b in the fourth path node 504a4 may receive a data unit included in exchanging data between the source node 502a and the third edge node 508a3. An ASD component 404b in the fourth path node 504a4 may detect a protocol address 1.2.2.3 in a destination address in the data unit and/or in a message transported the data unit and/or possibly other data units. The ASD component 404b may determine that the protocol address identifies the fourth path node 504a4 to the source node 502a. As described above, fourth path node 504a4 may receive hop information that identifies a hop identifier for the sixth hop 510a6. The ASD component 404b in the fourth path node 504a4 may provide the hop identifier 2 and the protocol address 1.2.2.3 to a topology component 406. The topology component 406 may operate in the fourth path node 504a4, the destination node 506a, the source node 502a, and/or any node in network 500a. The topology component may operate in a topology service and/or with a naming service such as DNS service. The topology component 406 may determine, based on the protocol address that identifies the fourth path node 504a4 to the source node 502a and based on the hop identifier 2 that identifies the sixth hop 510a6, a protocol address 1.2.2.3.2 that identifies the destination node 506a to the source node 502a. The topology component 406 may also determine a protocol address 1.2.2.2.2 that also identifies the destination node 506a to the source node 502a.

In an analogous manner, a protocol address 0.1.0.0.0 and/or a protocol address 0.3.0.0.0 may be determined as respective protocol addresses that each identify the source node 502a with respect to the destination node 506a.

With respect to FIG. 5B, in another aspect, for a network path from a destination node 506b to a first path node 504b1, an IDH component 409b1 in the first path node 504b1 may receive a destination address in a data unit included in sending data from the first path node 504b1 to the destination node 506b. The data in the data unit may have been received by the first path node 504b1 in a data unit sent from a first edge node 508b1 including a destination address that identifies the destination node 506b with respect to the first edge node 508b1. The protocol address that identifies the destination node 506b to the first path node 504b1 may be represented as 0-1.0-105, based on an address representation illustrated in FIG. 6C or in an analogous representation. A corresponding protocol address that identifies the first path node 504b1 with respect to the destination node 506b may be represented as 105-0.1-0.

As described above, the first path node 504b1 may receive hop information that identifies a hop identifier for the first hop 510b1. An ASD component 404b in the first path node 504b1 may provide a hop identifier 1-151 and the protocol address 105-0.1-0 to a topology component 406. The topology component 406 may operate in first path node 504b1, destination node 506b, source node 502b, and/or any node in network 500b. The topology component 406 may determine, based on the protocol address that identifies the first path node 504b1 to the destination node 506b and based on the hop identifier 0-151 that identifies the first hop 510b1 to the first path node 504b1, a protocol address 105-0.1-0.1-151 that identifies the source node 502a to the destination ode 506a. The topology component 406 may also determine a protocol address 151-1.0-1.0-105 that identifies the destination node 506a to the source node 502a.

With respect to FIG. 5C, in another aspect, for a network path from a source node 502c to a seventh path node 504c7, an IDH component 409b1 in the seventh path node 504c7 may receive a destination address in a data unit included in sending data from the source node 502c to the seventh path node 504c7. The destination address may be represented as 101.0.1.3.2. A corresponding source address may also be represented as 0.2.3.1.0.101 and may also be received by the IDH component 409b1. The in-data handler component 409b1 may provide and/or otherwise identify the destination protocol address and/or the source protocol address to an ASD component 404b. As described above, an in-data handler component 409b1 may provide and/or otherwise identify one or protocol addresses included in the destination protocol address and/or one or more protocol addresses included in the source protocol address to address space director component 404a. For example, 2.3.1 in the source address is a protocol address that identifies a second path node 504c2 to the seventh path node 504c7 for a network protocol.

A topology component 406 may operate in the seventh path node 504c7, the source node 502c, a fourth edge node 508c4, and/or any node in network 500c. The topology component 406 may determine, based on the protocol address, 101.0.1.3.2, that identifies the seventh path node 504c7 to the source node 502c and based on the hop identifier 2 that identifies the ninth hop 510c9 to the fifth path node 504c5, a protocol address 101.0.1.3 that identifies the fifth path node 504c5 to the source node 502c. The topology component 406 may determine other protocol addresses based on the address 101.0.1.3.2 and/or 2.3.1.0.101 and based on hop information for other hops. For example, a topology component 406 may determine a protocol address, 101.0.1.3.2.1, that identifies a second edge node 508c2 to the source node 502c based on the protocol address 101.0.1.3.2 and the hop identifier 1 for the hop that includes the second edge node 508c2 and the seventh path node 504c7.

In a further aspect, a hop identifier may identify a hop to a node where the node is not in the hop. For example, 0.2 may be a hop identifier for the seventh path node 504c7 for an eighth hop 510c8 illustrated in FIG. 5C. The eighth hop 510c8 includes a fourth edge node 508c4 and a sixth path node 504c6. A topology component 406 may determine the protocol address 101.0.1.3.2.0.2 based on the address 101.0.1.3.2 that identifies the seventh path node 504c7 to the source node 502c, and based on the hop identifier 0.2 that identifies the eighth hop 510c8 to the seventh path node 504c7.

As described above, one or more nodes in a network 500, as illustrated in FIGS. 5A-C, may individually or cooperatively operate to perform the method of FIG. 2. An adaptation, analog, and/or instance of the arrangement of components in FIG. 3 may operate in a topology service that includes a topology node in a network. Hop information and protocol addresses may be detected and/or reported to the topology node. The topology node may create, update, and/or otherwise maintain a representation of a topology of some or all of a network. The topology node may be included in a group of topology nodes in a topology service or system. Each of the topology nodes may maintain a representation of a topology for a portion of the network and/or for the entire network. As used herein, the term topology node is used interchangeably with the term topology execution environment, which is an execution environment that hosts a topology service or a portion thereof. A topology execution environment may include and/or otherwise be hosted by one or more nodes.

In an aspect, a topology system may include topology nodes organized as a hierarchy of topology nodes that maintain a hierarchy of the representations of respective portions of a topology of a network. In another aspect, topology nodes may operate in a peer-to-peer system.

A topology component 406 in a node may receive topology information that associates the a second protocol address determined based on hop information and based on a first protocol address with a network path that includes path end nodes of the network path.

In yet another aspect of the method, in FIG. 2, the second protocol address may be associated with a symbolic identifier of one of the path end nodes of the network path. The symbolic identifier may be resolved to the second protocol address and vice versa. A topology component 406 may maintain associations that identify a symbolic identifier and one or more protocol addresses for a node identified by the symbolic identifier. Alternatively or additionally, a topology component 406 may send at least one of the first hop information and the first protocol address to a topology node that maintains a representation of a topology of at least a portion of the network that includes at least one of the a hop, a first node, and a second node, where at least the second node is not in the hop.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more of an electronic, magnetic, optical, and electromagnetic form, such that the instruction execution machine, system, apparatus, or device may read (or fetch) the instructions from the non-transitory computer readable storage medium and execute the instructions for carrying out the described methods. A non-exhaustive list of conventional exemplary non-transitory computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-Ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for determining a protocol address for a node, the method comprising:
identifying a first hop identifier that is, for a first node in a network, an identifier of a first hop that includes a pair of consecutive nodes in a network path in the network;
receiving a first protocol address that for a network protocol at least one of identifies the first node to a second node in the network and identifies the second node to the first node, wherein the second node is not in the first hop; and
determining, based on the first protocol address and the first hop identifier, a second protocol address that for the network protocol at least one of identifies, to the second node, a node in the first hop that is not the first node and identifies the second node, to a node in the first hop, that is not the first node,
wherein performing at least one element comprising the method includes execution of an instruction by a processor.

2. The method of claim 1 wherein identifying the first hop identifier includes:
receiving hope information about the first hop; and
identifying the first hop identifier based on the hop information, wherein the hop information is included in topology information identifying a network topology that respectively includes representations of the first node and the first hop.

3. The method of claim 1 wherein the first node is one of included in the first hop and not included in the first hop.

4. The method of claim 1 wherein the first hop identifier is identified based on at least one of a first network interface in the first node and a second network interface in a node in the first hop.

5. The method of claim 1 wherein the network protocol is a network layer protocol and the first hop identifier is in an address space of link layer protocol and identifies, for the link layer protocol, a node in the first hop to the other node in the first hop.

6. The method of claim 1 wherein identifying the first hop identifier includes determining that the first hop identifier meets a hop identifier criterion that specifies that the first hop identifier meets a size threshold identified by the hop identifier criterion.

7. The method of claim 6 wherein the hop criterion is based on a count of network interfaces included in at least one of the first node and a node in the first hop,

8. The method of claim 1 wherein the hop identifier includes a path identifier that identifies a network path included in communicatively coupling first node to a node in the first hop.

9. The method of claim 1 wherein the first hop identifier includes a protocol address for the network protocol that at least one of identifies the first node to a node in the first hop and identifies a node in the first hop to the first node.

10. The method of claim 1 wherein the first protocol address at least one of identifies a protocol endpoint, of the network protocol, in the first node to the second node and identifies a protocol endpoint, of the network protocol, in the second node to the first node.

11. The method of claim 1 wherein receiving the first protocol address includes detecting the first protocol address as a portion of a second protocol address.

12. The method of claim 1 wherein receiving the first protocol address includes detecting the first protocol address in at least one of a destination address field and a source address field of a data unit of the network protocol.

13. The method of claim 1 wherein receiving the first protocol address includes detecting the first protocol address in a message transported by at least one data unit of the network protocol.

14. The method of claim 1 wherein at least one element comprising the method is performed by at least one of the first node, the second node, a node in the first hop, and a topology node in the network that maintains a representation of a topology of at least a portion of the network.

15. The method of claim 14 wherein the topology node is included in a plurality of topology nodes that each maintains a representation of a topology for at least a portion of the network.

16. The method of claim 15 wherein the topology nodes in the plurality are organized as a hierarchy of topology nodes that maintain a hierarchy of the representations of the topologies for the respective at least a portion of the network.

17. The method of claim 1 further includes sending topology information that associates the second protocol address with a network path that includes the second node and the first hop.

18. The method of claim 1 wherein method includes:
receiving a request to resolve a first symbolic identifier that identifies one of a node in the first hop and the second node;
determining the second protocol address, in response to receiving the request; and
sending a response identifying the second protocol address.

19. A system for determining a protocol address for a node, the system comprising:
a hop manager component that during operation of the system is included in identifying a first hop identifier that is, for a first node in a network, an identifier of a first hop that includes a pair of consecutive nodes in a network path in the network;
an address space director component that during operation of the system is included in receiving a first protocol address that for a network protocol at least one of identifies the first node to a second node in the network and identifies the second node to the first node, wherein the second node is not in the first hop;
a topology component that during operation of the system is included in determining, based on the first protocol address and the first hop identifier, a second protocol address that for the network protocol at least one of identifies, to the second node, a node in the first hop that is not the first node and identifies the second node, to a node in the first hop, that is not the first node; and
a processor, wherein at least one of the hop manager component, the address space director component, and the topology component includes an instruction that is executed by the processor during operation of the system.

20. A non-transitory computer-readable medium embodying a computer program, executable by a machine, for determining a protocol address for a node, the computer program comprising executable instructions for:
identifying a first hop identifier that is, for a first node in a network, an identifier of a first hop that includes a pair of consecutive nodes in a network path in the network;
receiving a first protocol address that for a network protocol at least one of identifies the first node to a second node in the network and identifies the second node to the first node, wherein the second node is not in the first hop; and
determining, based on the first protocol address and the first hop identifier, a second protocol address that for the network protocol at least one of identifies, to the second node, a node in the first hop that is not the first node and identifies the second node, to a node in the first hop, that is not the first node.
